(19) United States
(12) Patent Application Publication
(10) Pub. No.: US 2003/0120928 A1
(43) Pub. Date: Jun. 26, 2003

(54) Methods for rights enabled peer-to-peer networking

(76) Inventors: Miles Cato, San Francisco, CA (US); Lonny J. Cordell, Plano, TX (US); Robert P. Weber, Menlo Park, CA (US)

Correspondence Address: Miles Cato, 1808 Pacific Avenue, #304, San Francisco, CA, 94109, US

(21) Appl. No.: 10/224,107

(22) Filed: Aug. 20, 2002

(30) Foreign Application Priority Data
Dec. 21, 2001 (WO) PCT/US01/49735

(51) Int. Cl. H04L 9/00

(52) U.S. Cl. 713/176; 713/193

(57) ABSTRACT

The present invention relates to digital rights management. In one embodiment, persons, processes, and/or computers and appliances locate, share, publish, retrieve, and use all kinds of digital information that has been protected using digital rights management technologies. Rights management includes securely associating rules for authorized use with the digital information. Rules and/or digital information may be encapsulated in a cryptographically secure data structure or “container” (“CSC”) to protect against unauthorized use, to ensure secrecy, to maintain integrity, and to force the use of a rights management system to access the protected information. Attributes or metadata information describing at least some of the rules (“rules-metadata information”) and optionally any associated rule parameter data with respect to the protected information are created. This rules-metadata information may be organized, structure, encoded, and/or presented using a self-defining data structure such as those created using Extensible Markup Language (XML). In one embodiment, the XML-encoded rules-metadata information is also made available unencrypted, in plain text, to facilitate P2P search and file transfer. Having at least some of the rules-metadata information outside or external to a CSC allows greater flexibility in searching based at least in part upon the rules-metadata information. Some embodiments may hold the rules-metadata information in a separate CSC. Putting the rules-metadata information in a separate CSC more easily allows authentication and maintains the integrity of the rules-metadata information. In another embodiment, the rules metadata may be in an unencrypted portion of a CSC itself or concatenated with a CSC in a single file.

### PRIORITY CLAIM

This application incorporates by reference and claims priority to a provisional application entitled “Rights Enabled Peer-to-Peer Networking” filed on Dec. 21, 2000, having an application No. 60/257,735; and a PCT application filed on Dec. 21, 2001, having an application No. PCT/US01/49735.

### BACKGROUND OF THE INVENTION

1. Field of the Invention

This invention relates in general to digital rights management technologies in controlling search and access of protected information and, more specifically, to digital rights management technologies in creating searchable secured containers for such protected information.

2. Description of the Prior Art

Digital rights management (DRM) technologies are used as the foundation for a broad range of commerce activities. Especially in the consumer and business information markets, a variety of DRM technologies are now provided in commercial software products and related services, including technologies and/or services based on these DRM technologies offered by InterTrust, Microsoft, and many others.

A DRM platform technology that may be utilized includes technologies created by InterTrust Technologies Corporation and described at least in part in U.S. Pat. No. 6,240,185 to Van Wie, et al., U.S. Pat. No. 6,237,786 to Ginter, et al., U.S. Pat. No. 6,185,683 to Ginter, et al., U.S. Pat. No. 6,157,721 to Shear, et al., U.S. Pat. No. 6,138,119 to Hall et al., U.S. Pat. No. 6,112,181 to Shear et al., U.S. Pat. No. 5,982,891 to Ginter et al., U.S. Pat. No. 5,949,876 to Ginter et al., U.S. Pat. No. 5,943,422, to Van Wie, et al., U.S. Pat. No. 5,920,861 to Hall et al., U.S. Pat. No. 5,917,912 to Ginter et al., U.S. Pat. No. 5,915,019 to Ginter et al., U.S. Pat. No. 5,910,987 to Ginter et al., U.S. Pat. No. 5,892,900 to Ginter et al., all of which are incorporated herein by reference.

Generally speaking, the InterTrust DRM platform is based on secure, tamper-resistant “nodes” that manage the authorized access and use of protected digital information of all kinds. In addition to nodes, the InterTrust DRM platform also includes a cryptographically secure software data structure or container that may protect any kind of digital information, such as documents, forms data, audio, video, software, and any other kind of digital information. The secure container may also protect for secrecy and/or integrity rules associated with the protected digital information. InterTrust refers to its commercially available nodes as InterRights™ Point software and their secure containers as DigiBOX™ containers.

Although the InterTrust DRM platform may be utilized, other companies also offer commercial DRM technologies that use some sort of client software and a secure container. Non-limiting examples include commercially available DRM technology from a Xerox spin-off, ContentGuard that is described at least in part in U.S. Pat. No. 5,715,403 issued to Stefik on Feb. 3, 1998; U.S. Pat. No. 5,638,443 issued to Stefik et al. on Jun. 10, 1997; U.S. Pat. No. 5,634,012 issued to Stefik et al. on May 27, 1997; U.S. Pat. No. 5,629,980 issued to Stefik et al. on May 13, 1997 which are incorporated herein by reference. Other DRM technology that entails the use of secure containers is described in U.S. Pat. No. 5,845,281 issued to Benson et al. on Dec. 1, 1998 which is incorporated herein by reference.

A major limitation of current secure containers defined by InterTrust and other commercial vendors is that end-users cannot determine in advance of attempting to open the secure container whether they will be, or want to be granted permission to access and use the protected information. For example, a consumer may not have sufficient credit or other funds to pay the amount or amounts required by the rules associated with protected content. In another example, they may not have sufficient and/or appropriate authority to access the protected information in accordance with the rules defined by rightsholders, their agents, and/or any other party. In yet another example, the rules may make access and use dependent upon the possession of a digital credential indicating membership in one or more classes or groups. Non-limiting examples of digital credentials include X.509 digital certificates known to those skilled in the arts and a protected object used as a digital credential by commercially available DRM technologies from InterTrust called a Membership Card. Non-limiting examples of class membership warranted or attested to by a Membership Card and/or combinations of Membership Cards include: “Platinum” level privileges, “Gold” level privileges, IRA account holder, Company employee, Executive level employee, Works at a particular office or other physical location, Contractor, Participant in airline or other affinity program, Member of a non-profit organization, or Any other class.

Computing architectures for locating, publishing, sharing, and/or retrieving digital information on the Internet and other networks are evolving and are faced with this major limitations as described above. In digital music distribution, for example, Napster and others typically provide a centralized search service combined with peer-to-peer file transfer for those files a user wishes to download or transfer to his or her computer. In such quasi-peer-to-peer services, the index of available files and their locations on the network are maintained centrally. When a user identifies a file they wish to retrieve, that file is usually transferred directly from one user or “peer” to another user or peer. This mode of operation is contrasted with client/server architectures in which both the searchable index of information and the files that may be retrieved are maintained in one logical location, that is, a location that appears as a single service and network location to the end-user.

These quasi-peer-to-peer architectures stand in contrast to true peer-to-peer file sharing now being developed and commercialized by a number of parties including an open-source development efforts referred to as Gnutella and several Gnutella variants, extensions, elaborations, etc. In true peer-to-peer file sharing, there is no central directory and all queries are sent from a peer to peers who individually respond to the query. Other peer-to-peer development efforts include the Freenet project initiated in the United Kingdom at Cambridge University by Ian Clarke and his colleagues, and several others. In the next few figures, examples of the workings of selected peer-to-peer network architectures are explained.

In referring to the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

Referring to FIG. 1, a block diagram of a prior art peer-to-peer network 100 of computers that communicate by direct links or through the Internet 104 is shown. Some of the virtual connections through the Internet 104 are shown as dotted lines. There are different types of computers, such as a portable audio player 108, personal digital assistants (PDAs) 112, personal computer servents 116, an appliance servent 120, and servers 124. Each computer has a network interface 128 and storage device(s) 132 of some sort. The storage devices 132 could include hard drives 132-1, solid-state memory (SSM) 132-2, or other non-volatile storage 132-3.

The computers provide and/or obtain files in a peer-to-peer manner to other computers by way of the Internet 104 without necessarily having to interact with a central information server. But, not all computers receive files from their peers, for example, the servers 124 provide files to the other computers without necessarily searching for and/or receiving any files directly from the other computers in this embodiment. Conversely, the portable audio player 108 receives files directly only from computer 116-2 and may send computer 116-2 acknowledgements and other administrative information. In this embodiment PDA 112 receives files from its peers, but typically does not serve files to its peers.

Network interfaces 128 allow the computers to communicate with each other. The communication can be direct as in the case of the portable audio player 108 communicating with the second computer servent 116 or as in the case of the servent 116 communicating with another servent and/or with server(s) 124 could be through the Internet 104.

The servers 124 could serve as a repository of search information for each computer. A query to the server would indicate what files were available where on the network. Alternatively, a search query could go to all the computers where each would respond with the appropriate search results.

Referring next to FIG. 2, a block diagram of a prior art client-server network 200 of computers that includes a data center 204 is shown. By way of a web browser 236 communicating through the Internet 104, client computers 208, 112, 212 communicate with a data center 204 to retrieve files from it. The portable audio player 108 in this example does not include a browser and receives its files by way of a browser-enabled computer 208-2.

The data center 204 provides files to the client computers 208, 112, 212 and may collect compensation for those files. Included in the data center 204 are the network interface 128, a web server 220, a data warehouse 224, a payment processor 228, and other components that are not shown. The web server 220 graphically interfaces users associated with the client computers 208, 112, 212 to the data warehouse 224 and the payment processor 228. Data files served from the data center 204 are stored in the data warehouse 224. Metadata and storage location for the files are accessible by the web server to provide directory information to the client computers 208, 112, 212. The payment processor 228 controls any payment needed.

It is noted that web server 220, payment processor 228, and data warehouse 224 can be logically arranged in any manner to perform the described function. For example, the data warehouse 224 could be integrated with the payment processor 228 where the integrated whole is located across the Internet 104 at a location remote to the data center 204. Additionally, some prior art embodiments may not include the payment processor 228 where the files are served without explicit monetary compensation from the user.

Referring next to FIG. 3, a graphical window 300 from a search in a prior art peer-to-peer network is shown. In this example, a search is made for the singer Bob Dylan by entering the string “dylan” on the search line 304 and clicking the search button 308. Five hits that match the search string are displayed in a results listing 312. A match means that “dylan” appears somewhere in the file name on a computer that complies with the minimum bandwidth specified. Attributes of the file such as name, size and speed of the sending server are listed in the results listing 312. If one or more listed files are CSCs, in prior art embodiments the information returned is that known by the file system on the peer on which the file resides. As noted, this information typically limited to file name, file extension or type, size, and perhaps creation or last modification date (not shown). Files from the listing can be selected and downloaded or streamed. As it can be seen, critical information with respect to rights management are sorely lacking in these architectures.

All of these limitations with respect to the currently available digital rights management related technologies provide the desire and market demand for a technology that is better suited for digital rights management of protected information in all network architectures such as the peer-to-peer architectures as well as the client/server architectures.

### SUMMARY OF THE INVENTION

It is therefore an object of the present invention to provide methods for digital rights management of protected information in all network architectures including peer-to-peer architectures;

It is another object of the present invention to provide methods for managing rights in accessing protected information in a network environment;

It is still another object of the present invention to provide methods for creating searchable secure containers that protect rules and digital content regardless of type.

The present invention relates to rights-enabled peer-to-peer networking. In one embodiment, persons, processes, and/or computers and appliances locate, share, publish, retrieve, and use all kinds of digital information that has been protected using digital rights management technologies. In some embodiments, rights management includes securely associating rules for authorized use with the digital information. Rules and/or digital information may be encapsulated in a cryptographically secure data structure or “container” to protect against unauthorized use, to ensure secrecy, to maintain integrity, and to force the use of a rights management system to access the protected information.

In one embodiment, attribute or metadata information describing at least some of the rules (“rules-metadata information”) and optionally any associated rule parameter data with respect to the protected information are created. This rules-metadata information may be organized, structure, encoded, and/or presented using a self-defining data structure such as those created using Extensible Markup Language (XML). In one embodiment, the XML-encoded rules-metadata information is also made available unencrypted, in plain text, to facilitate P2P search and file transfer. Having at least some of the rules-metadata information outside or external to a CSC allows greater flexibility in searching based at least in part upon the rules-metadata information. Some embodiments may hold the rules-metadata information in a separate CSC. Putting the rules-metadata information in a separate CSC more easily allows authentication and maintains the integrity of the rules-metadata information. In another embodiment, the rules metadata may be in an unencrypted portion of a CSC itself or concatenated with a CSC in a single file.

In one embodiment searching is performed upon the rules-metadata information stored or maintained external to the CSC that protects the digital information governed and/or managed by the rules. The search program does not need, therefore, to open a CSC to determine what rules govern the authorized use of the protected information within.

Search queries and search results can be sent to peer computers in the clear or in a CSC. Before download or transfer of any protected file from a peer computer, a search of the external, plaintext rules-metadata information can be performed. In one embodiment the user would be able to retrieve or download only those protected files that they were willing and/or able to use by virtue of their anticipated compliance with at least one rule associated with the protected information.

Watermarking technology is recognized in some embodiments. Before a file can be packaged in a CSC, the packaging application may check for watermarks using algorithms appropriate to the format of the information to be packaged, if any. If a watermark is found, packaging will not continue unless the packaging application can verify that the person requesting the packaging is authorized to do so. In one embodiment authorization is conveyed and/or indicated by the presence of one or more digital credentials. Without successful credential verification, the file will not be packaged.

Documenting copyright and similar violations on the Internet can be difficult. Before packaging an item, each user may queried to determine if they believe they are authorized to package and distribute the particular file to be packaged. Presuming they answer in the affirmative, the file is packaged and a non-reputable record of their answer and of the packaging action is sent to an audit clearinghouse in the form of an audit record. This audit record may contain various information, examples of which include the user ID and other identifying information of the user, the time and date of packaging, and information concerning the information in the package and associated rules.

For certain applications, such as file sharing and transfer with a business or among a business and its suppliers, partners, and/or customers, there is a desire to limit or restrict the participants in a peer group in a file sharing network. In one embodiment, there is a capability to create a subnet or subset of all possible peers by filtering on TCP port and/or rules. Other means for subsetting include restricting participation to computers having a particular qualified domain name and or by network addresses and/or address ranges. Additionally, search queries and results can be encapsulated in CSCs only viewable by those in the subnet defined using at least in part digital credentials. In this way, businesses or other organizations can create sub-groups within a larger, extended P2P system.

The present inventions enable users of P2P, and other kinds of file sharing applications such as quasi-peer-to-peer, client/server, and traditional search and retrieval applications at least in part, to conveniently: (1) Define rules for managing access to, and use of their digital content; (2) Create a SSC that protects rules and digital content regardless of type (e.g., image, text, audio, video, software); (3) Publish the SSC to any or a subset of users of the P2P system; (4) Search a network of P2P clients, including Gnutella clients, for any file whether protected or not; (5) Locate Rights-searchable secure containers; (6) Search by rules and rule elements; (7) Determine in advance of retrieving the published files the rules and conditions of use associated with each protected file in the Rights-searchable secure container; (8) Using efficient P2P file transfer, retrieve any or all published files without having to use a central site or server; (9) Use protected information in accordance with rules associated with that file; (10) Optionally charge for the authorized use of their digital assets; (11) Optionally collect usage information in accordance with privacy agreements; (12) Optionally designate a financial clearinghouse; (13) Optionally designate a usage clearinghouse; (14) Where charges apply, conveniently pay for the use of protected digital content; (15) Recognize many contexts where “fair use” or “fair dealing” exemptions may apply and provide rules that explicitly authorize use for these fair use contexts; and (16) Support corporate internal “chargeback” accounting through the use of audit or financial clearing records.

An advantage of the present invention is that it provides methods for digital rights management of protected information in all network architectures including the peer-to-peer architecture;

Another advantage of the present invention is that it provides methods for managing rights in accessing protected information in a network environment;

Still another advantage of the present invention is that it provides methods for creating searchable secure containers that protect rules and digital content regardless of type.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

FIG. 1 is a block diagram of a prior art peer-to-peer network of computers;

FIG. 2 is a block diagram of a prior art client-server network of computers that includes a data center; computers;

FIG. 3 is a block diagram of an embodiment of a peer-to-peer network of computers that includes a centralized data center;

FIG. 4 is a graphical window from a prior art peer-to-peer network that shows search results;

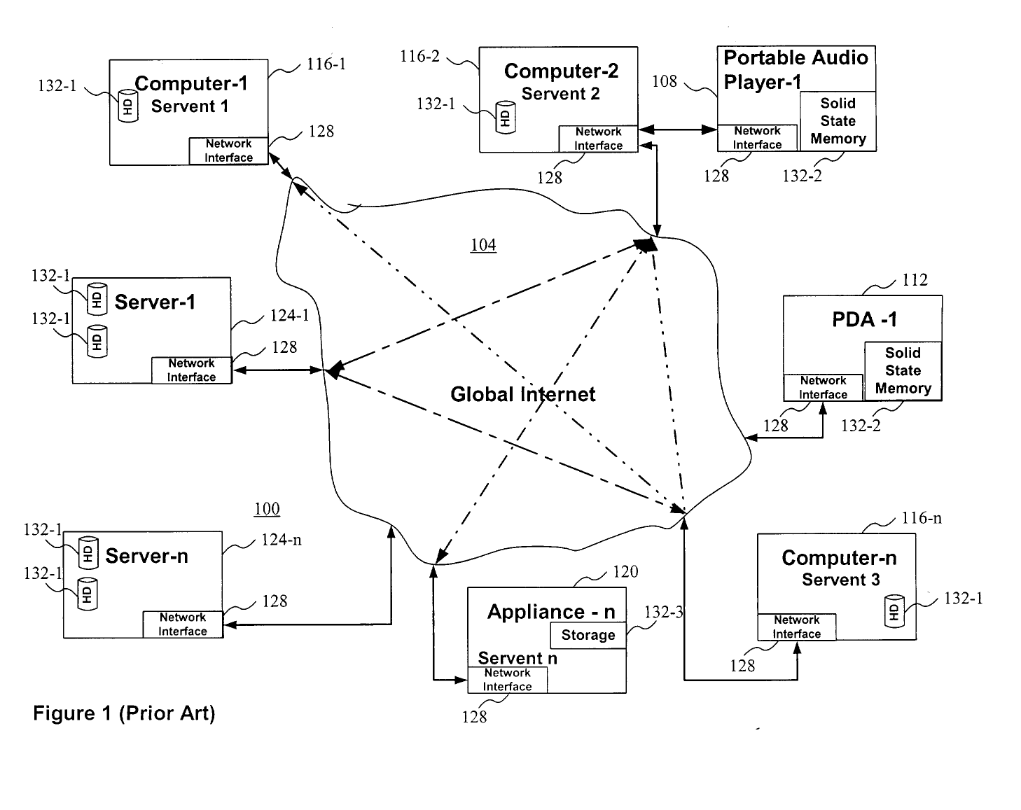

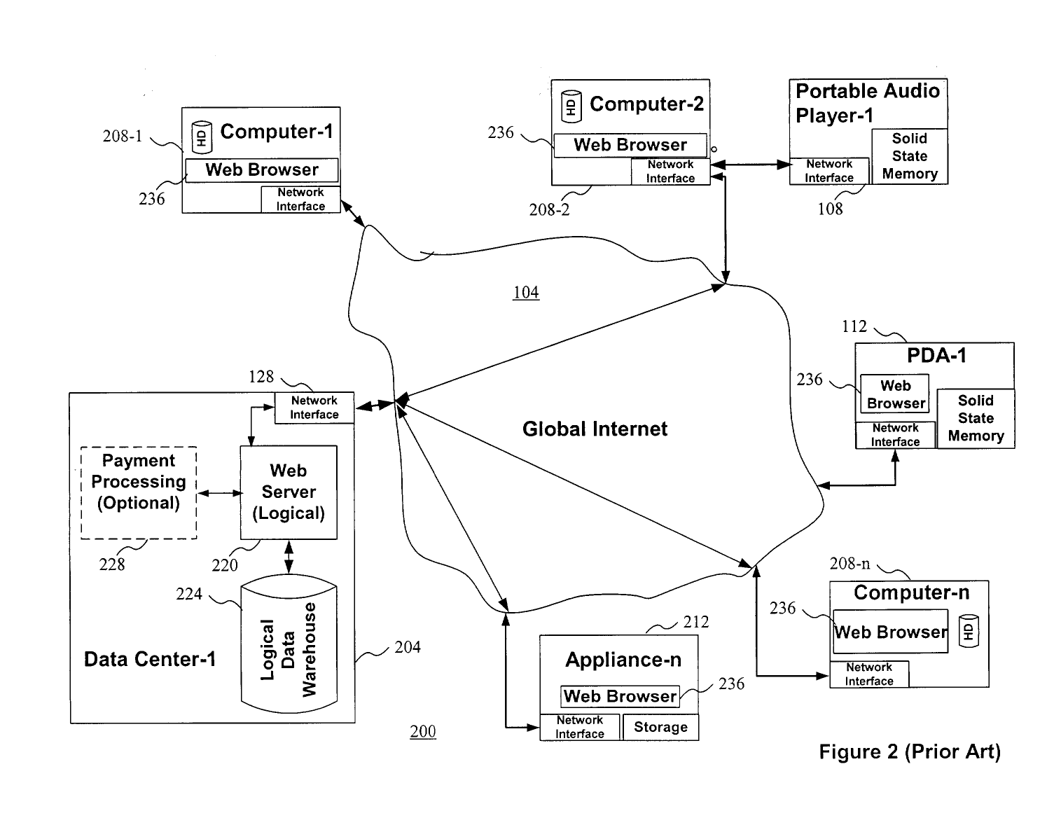

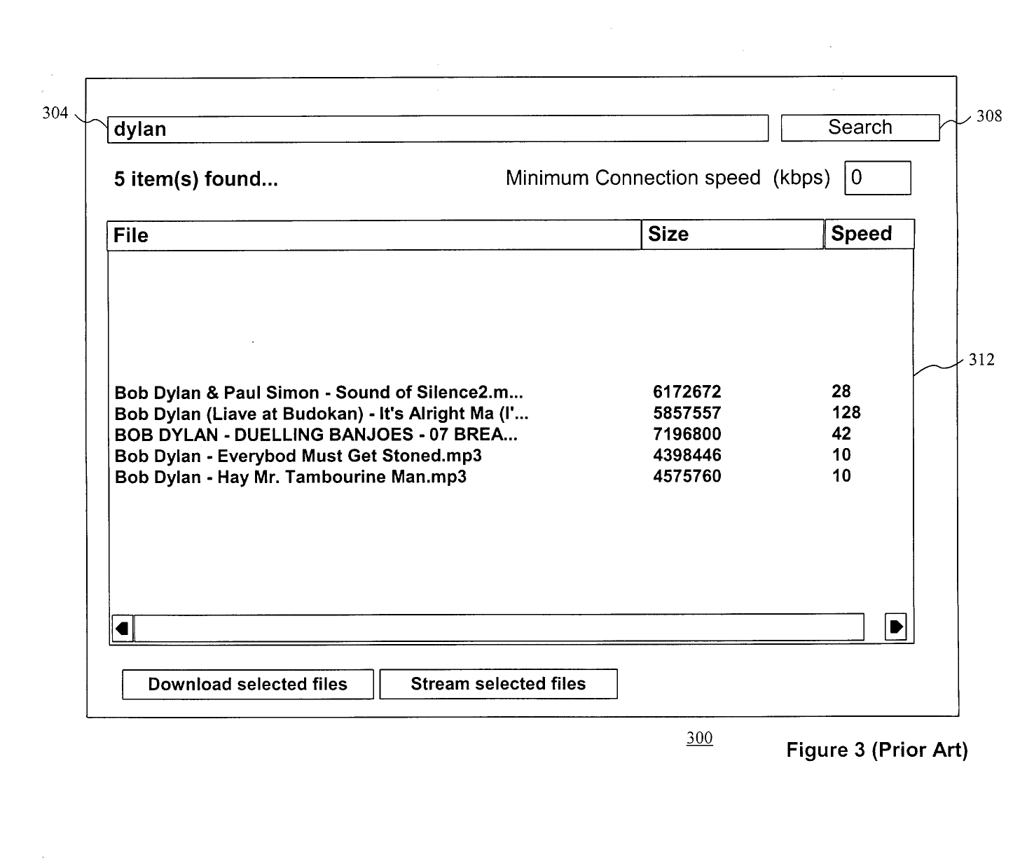

FIG. 3 is a block diagram of an embodiment of a rights-enabled appliance with a trusted computing base;

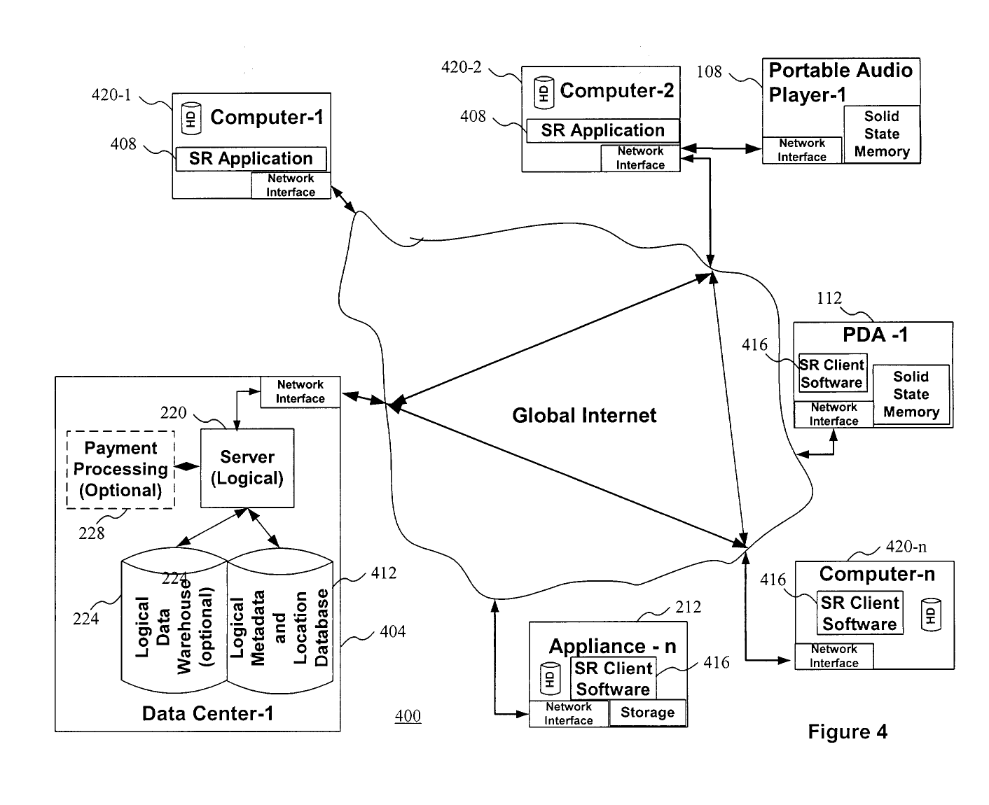

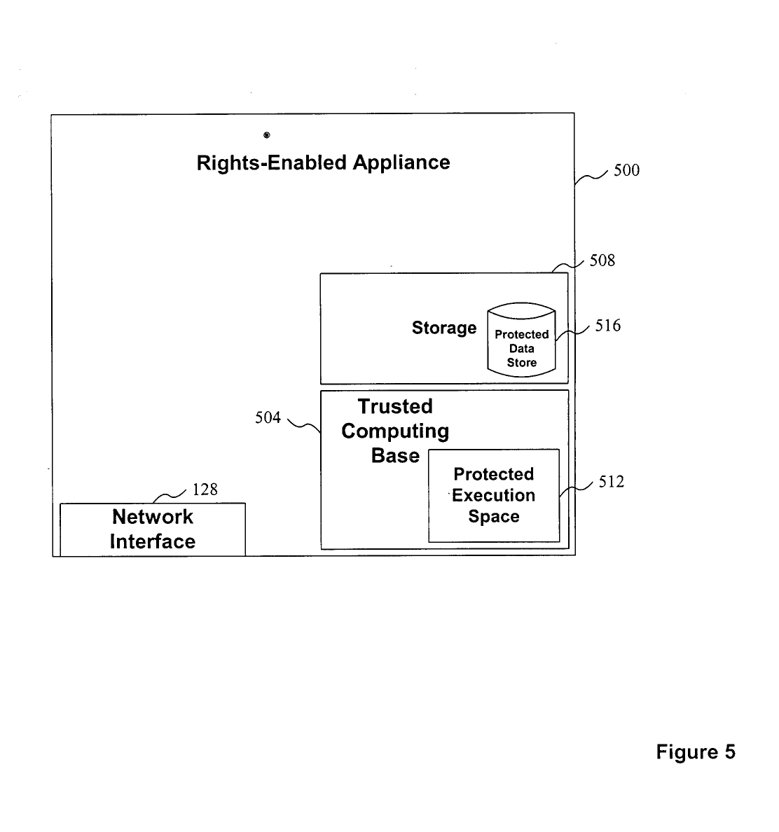

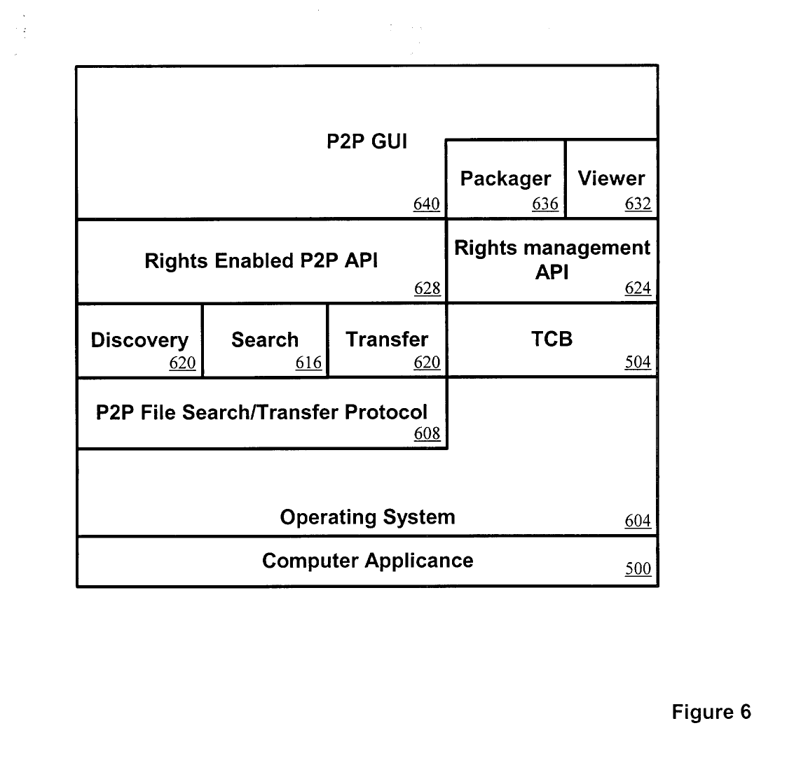

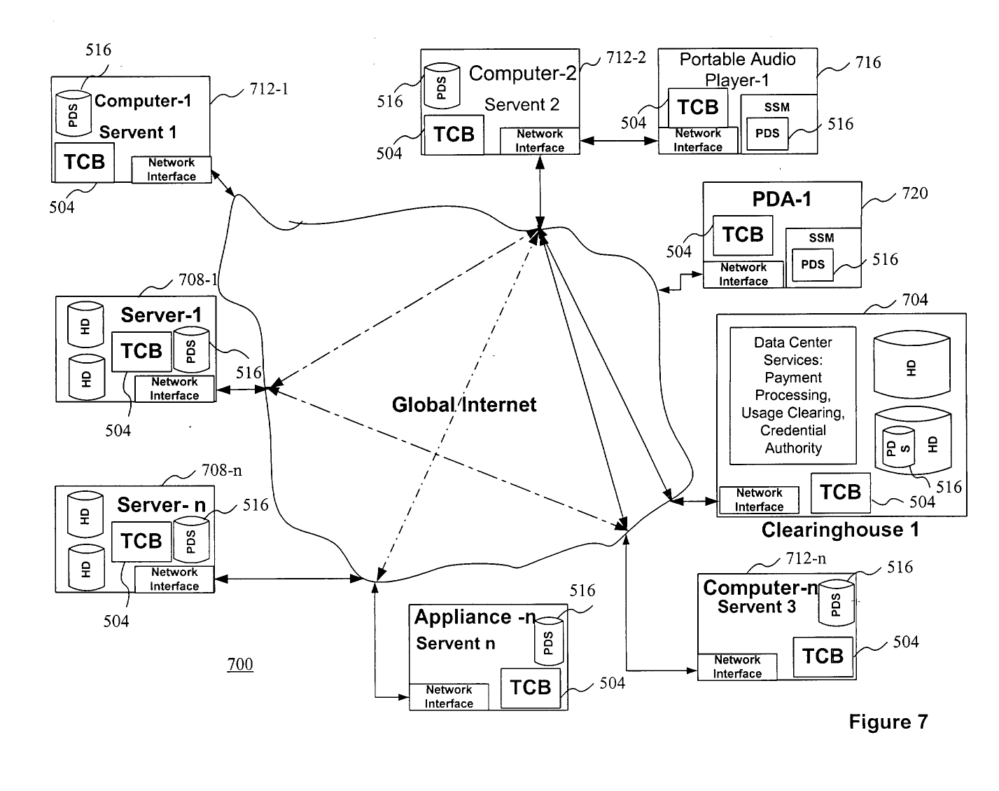

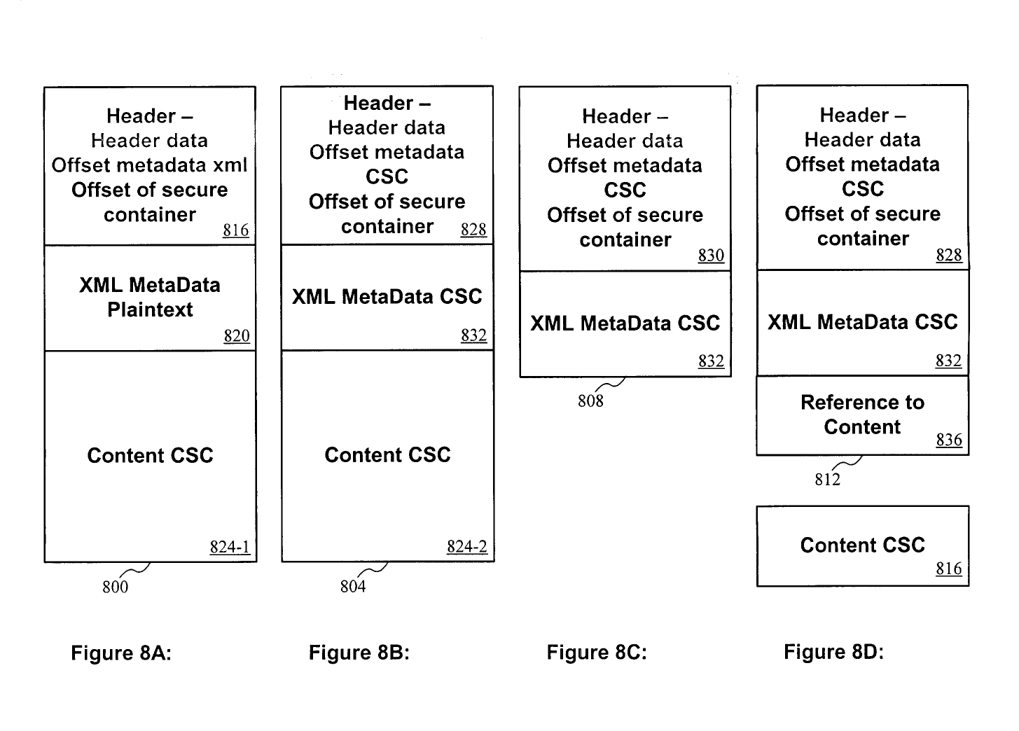

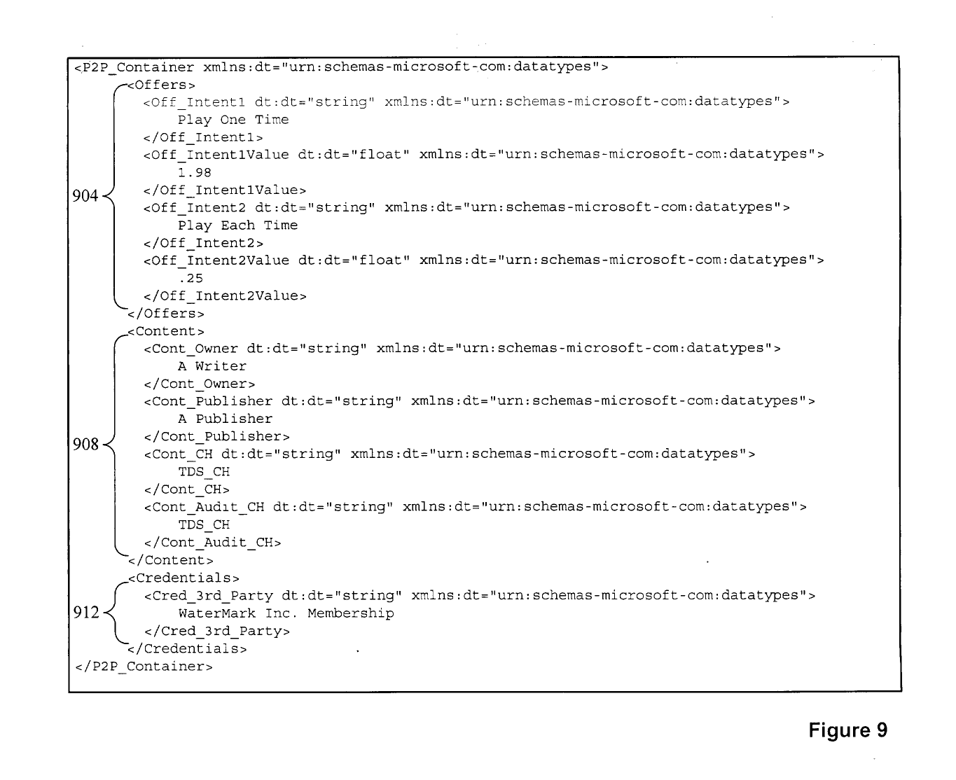

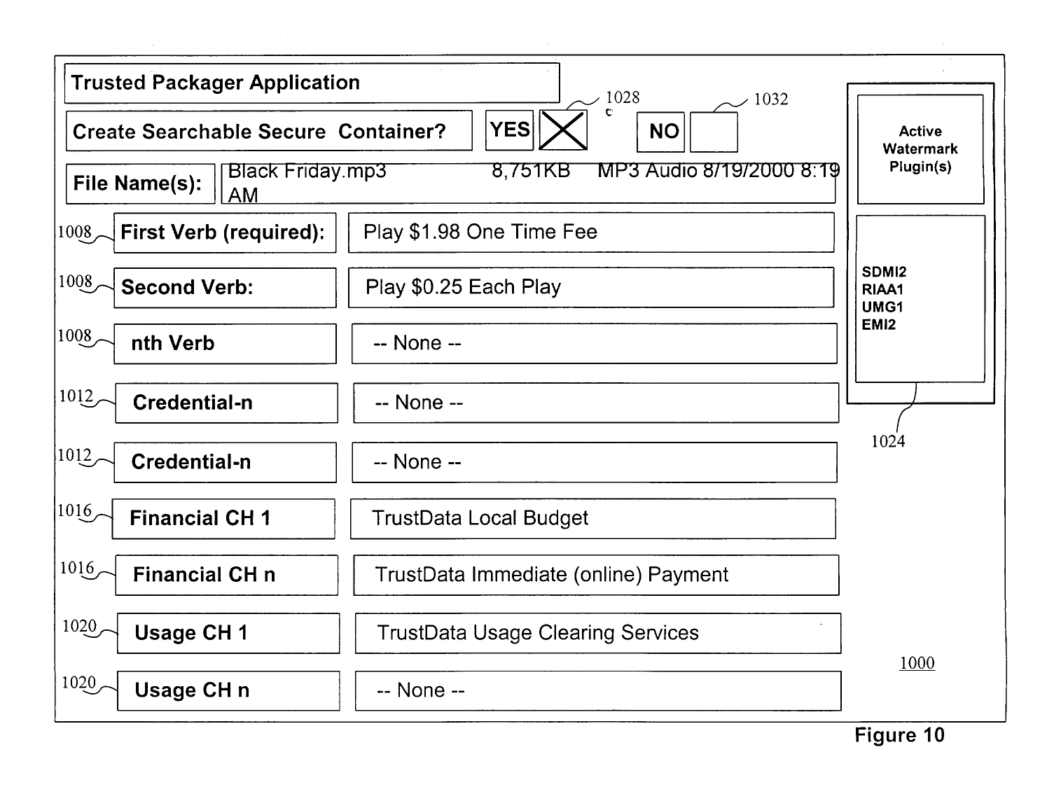

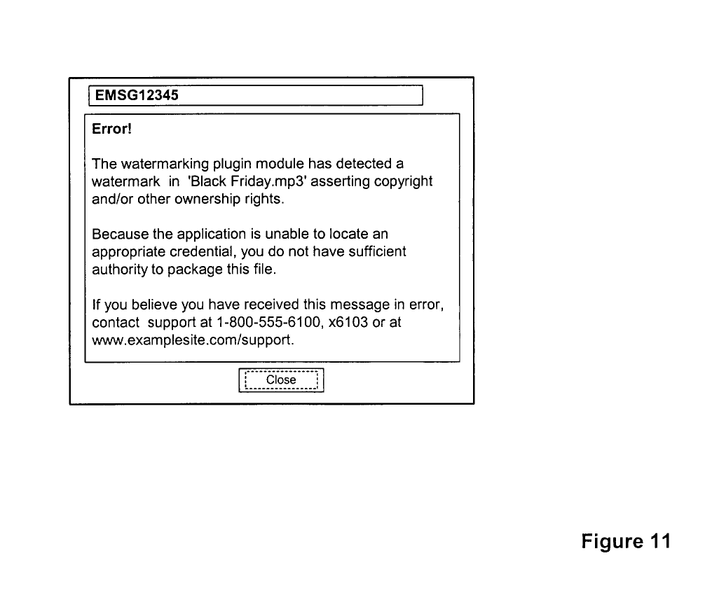

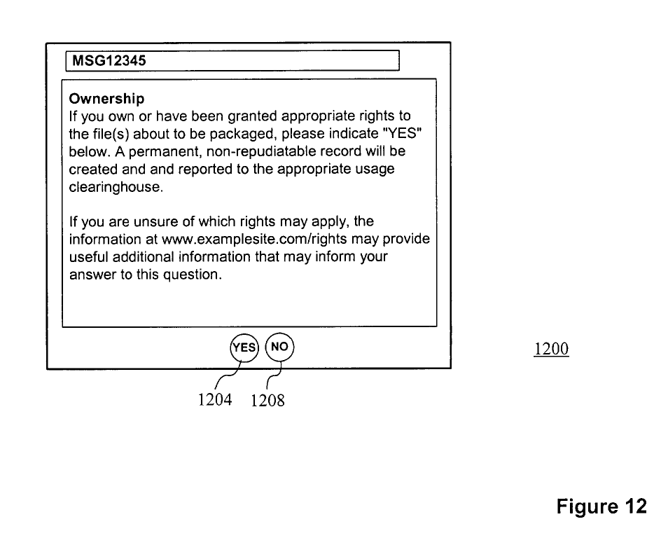

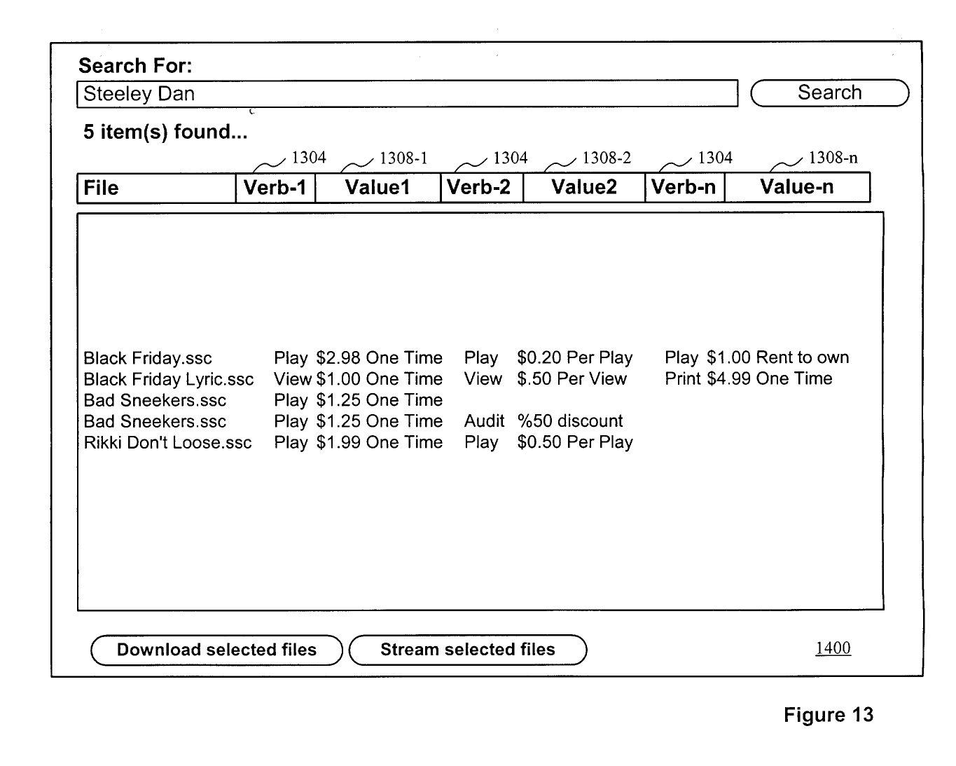

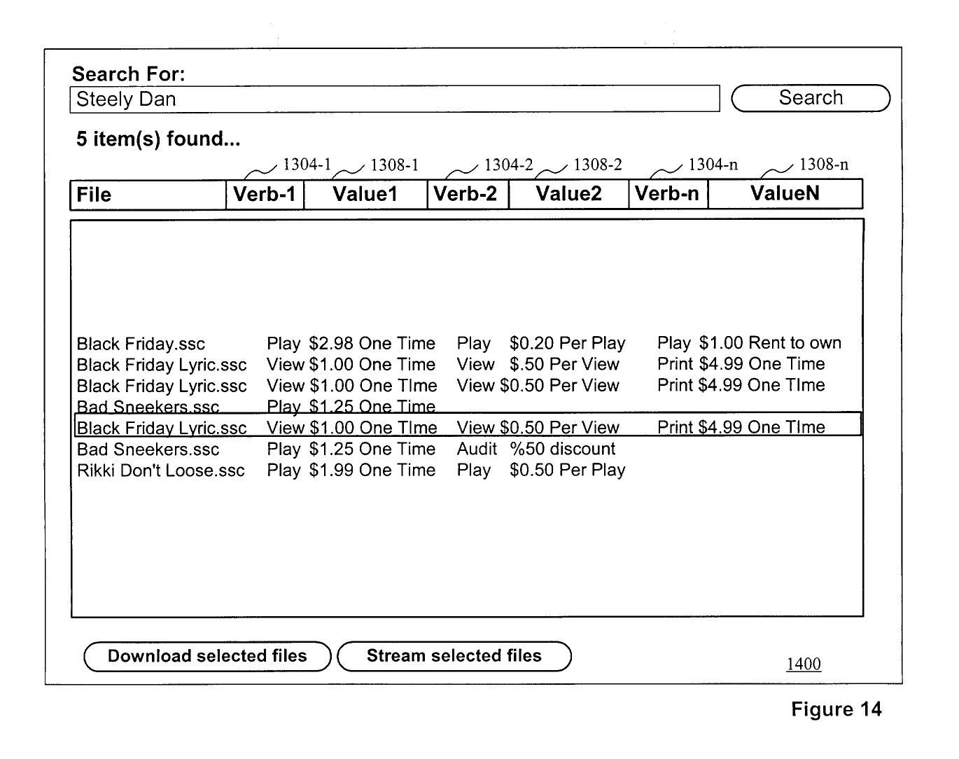

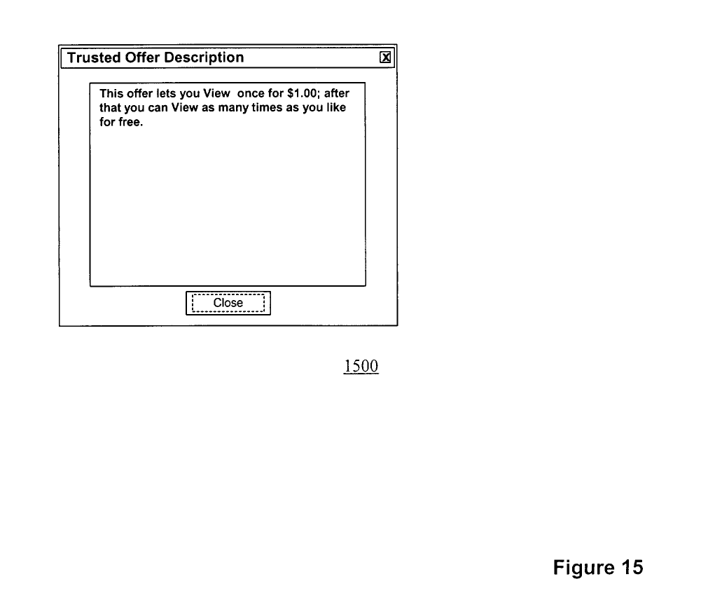

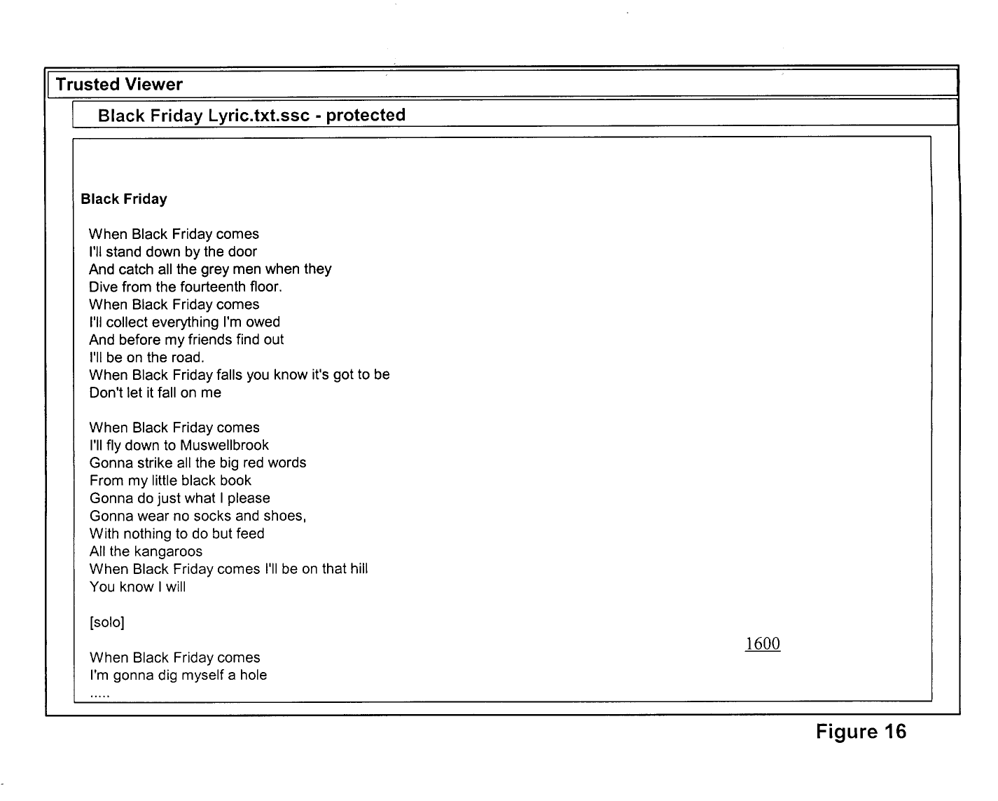

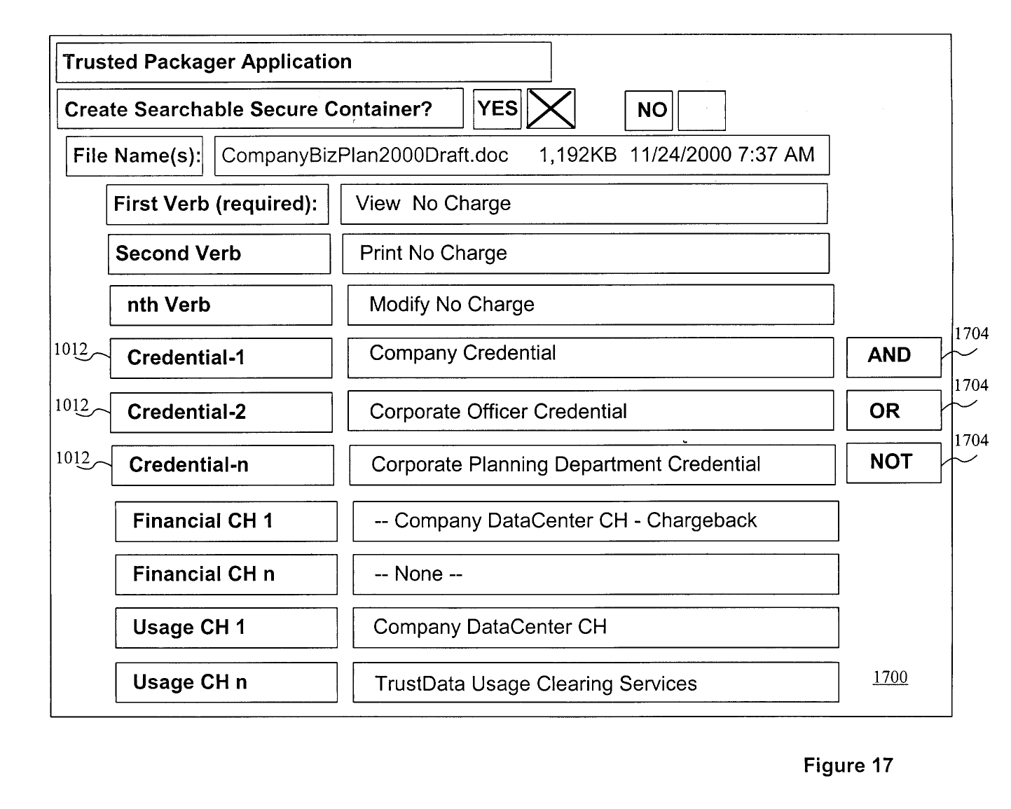

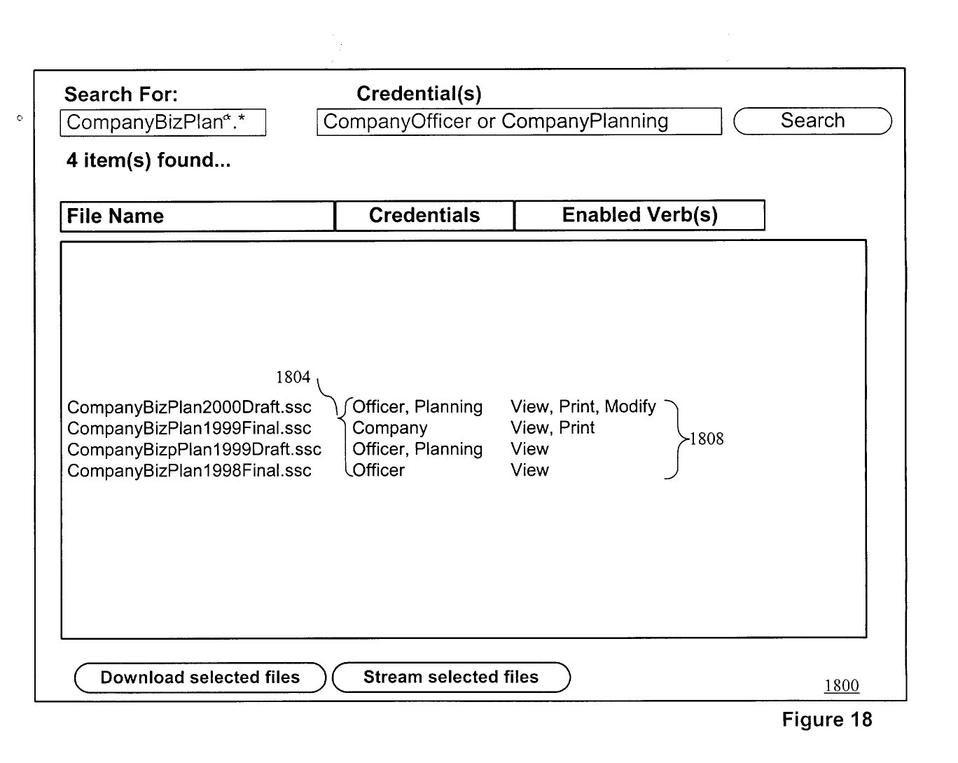

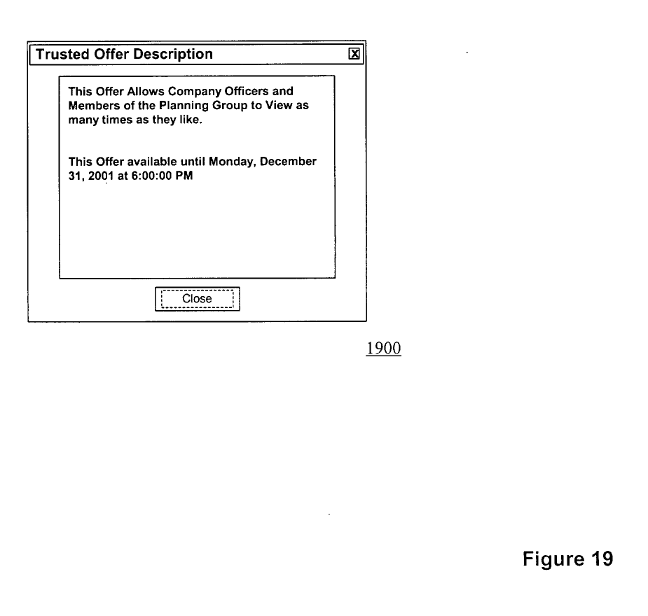

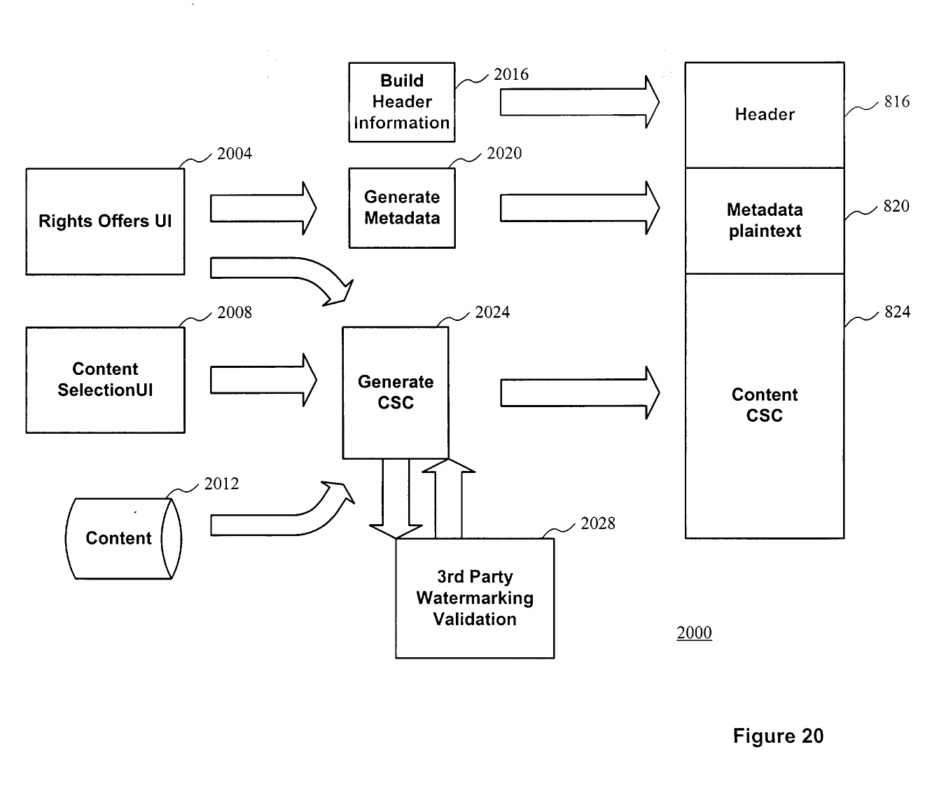

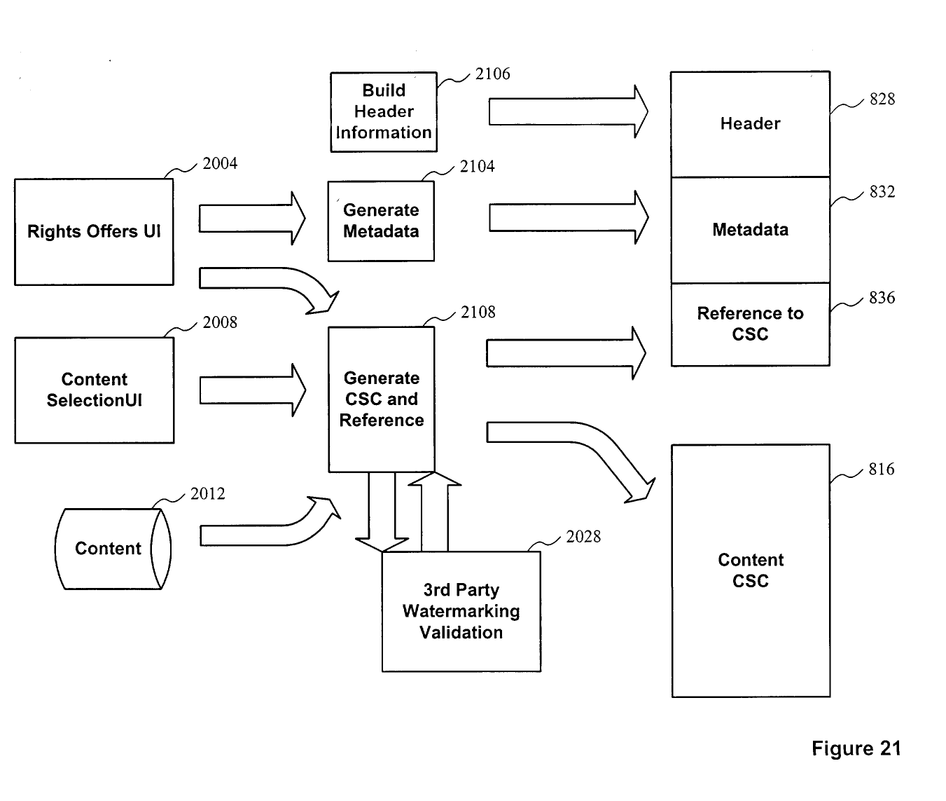

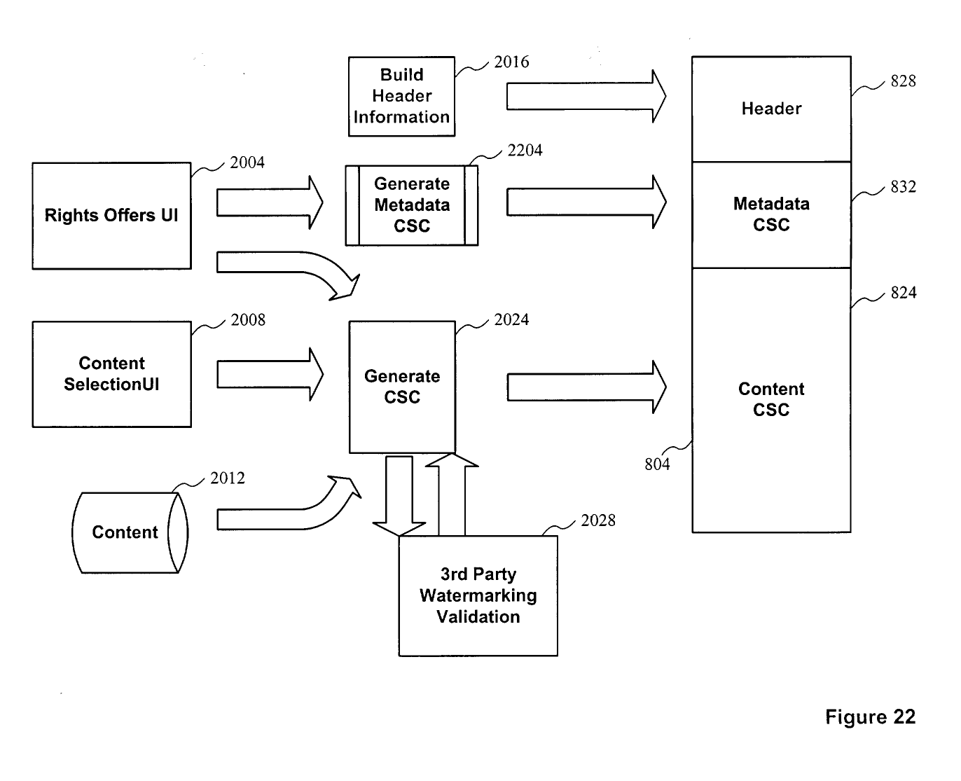

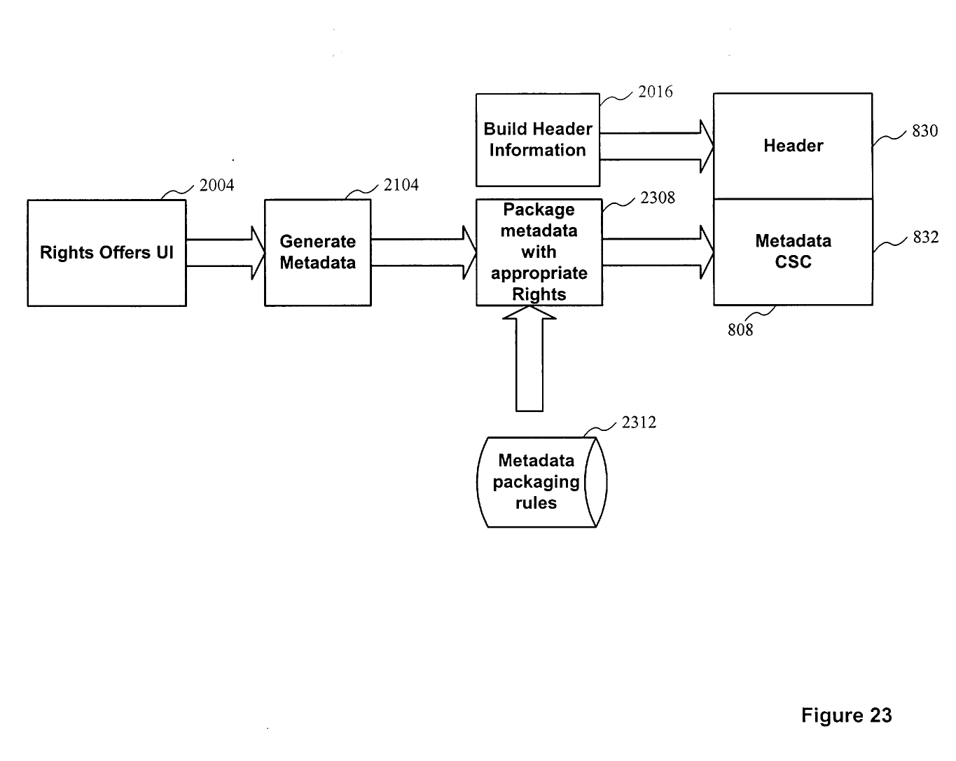

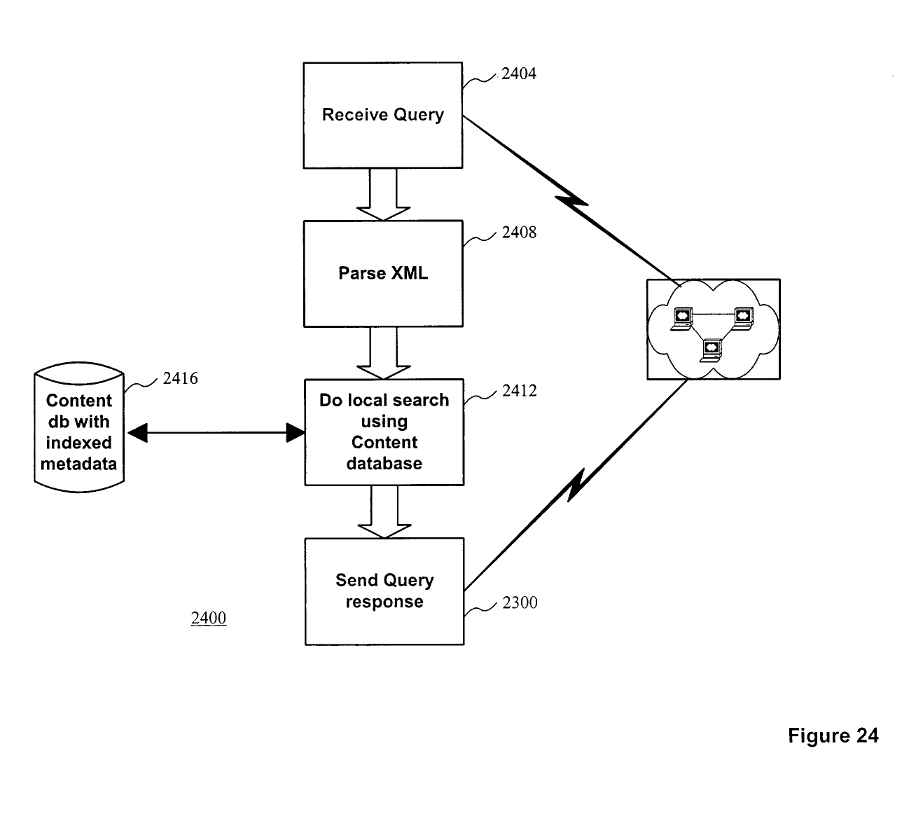

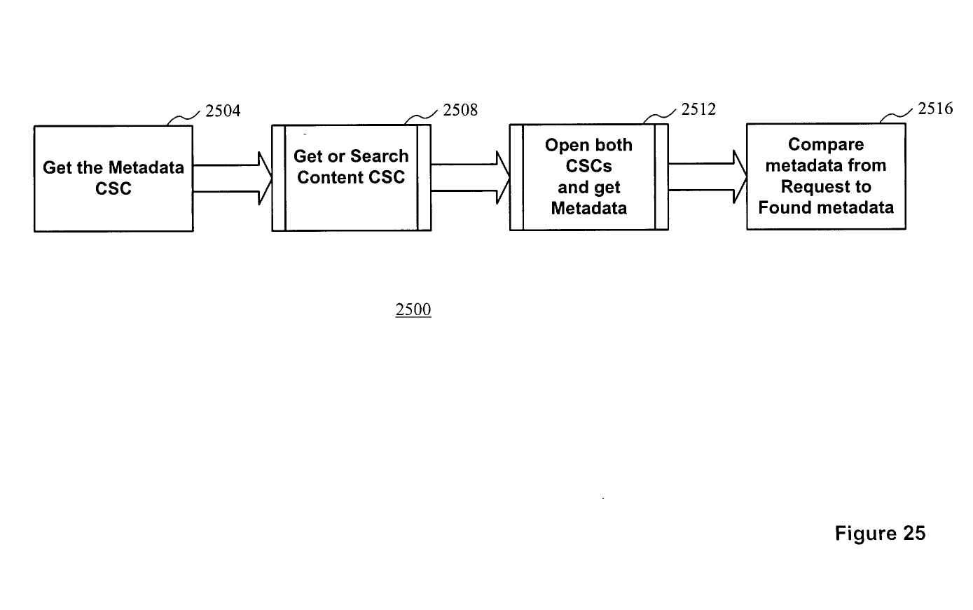

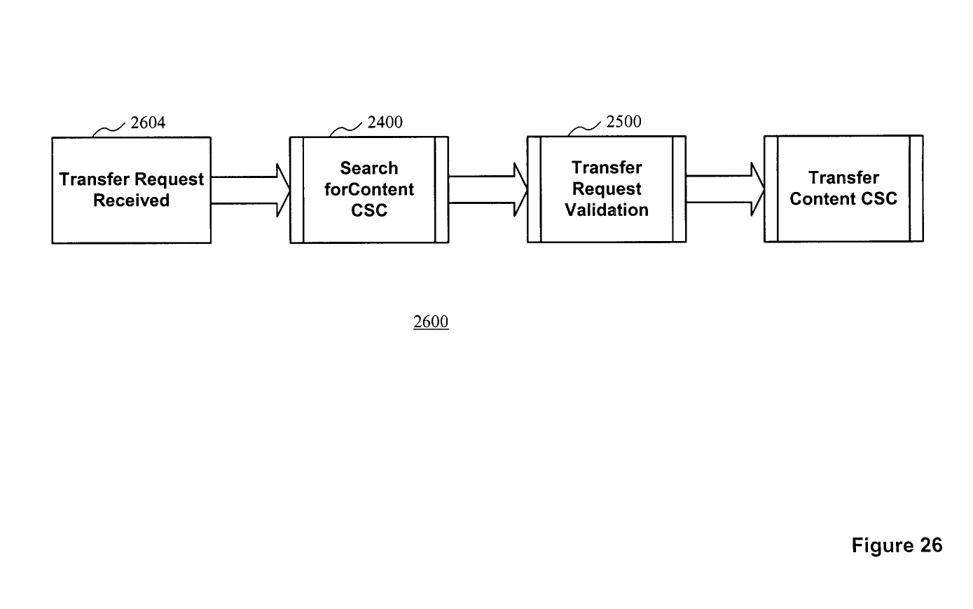

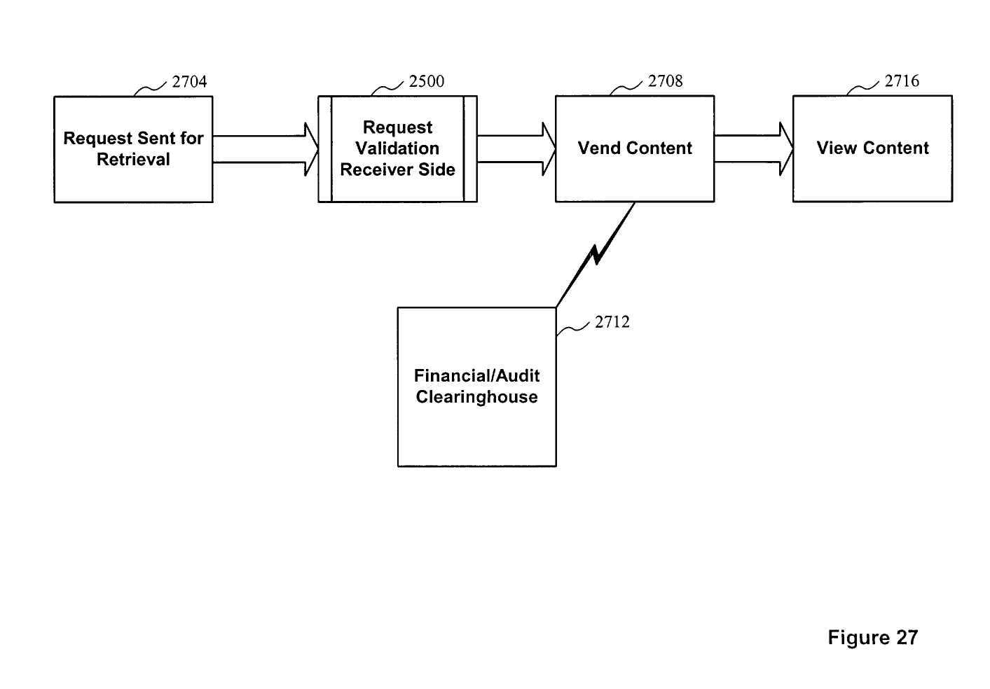

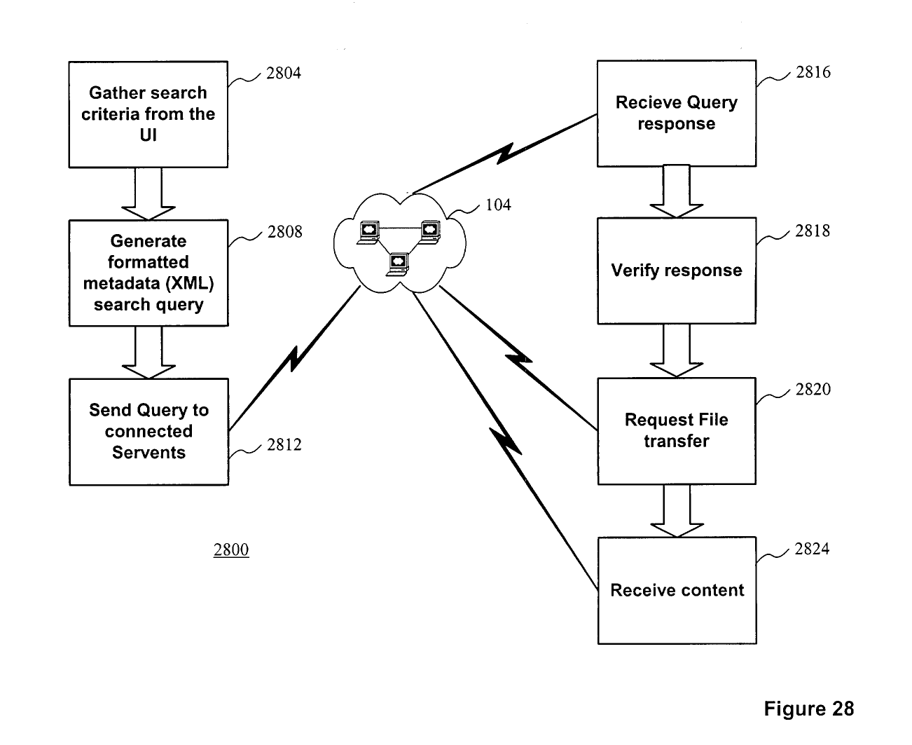

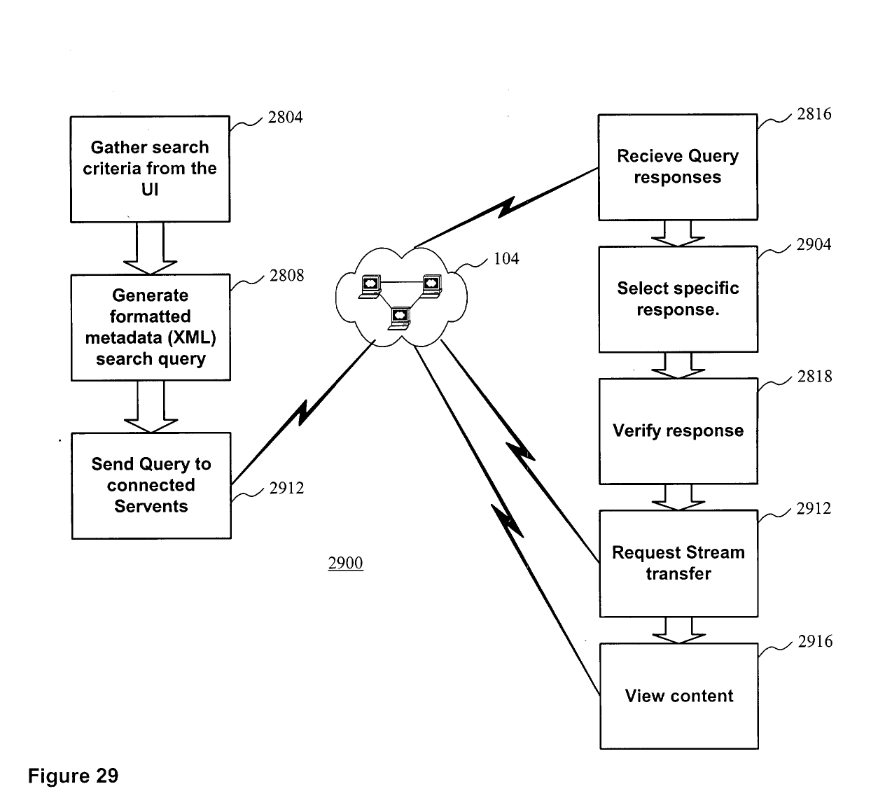

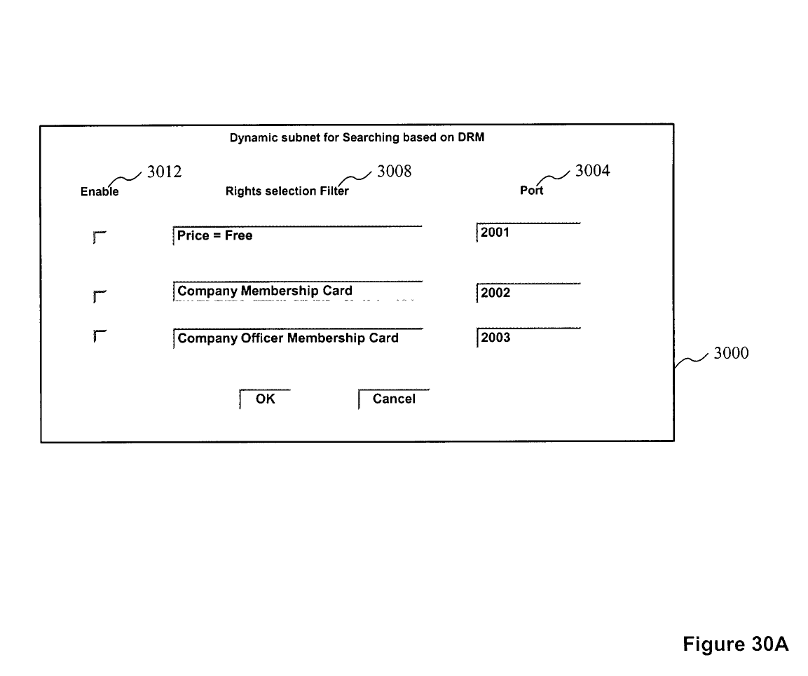

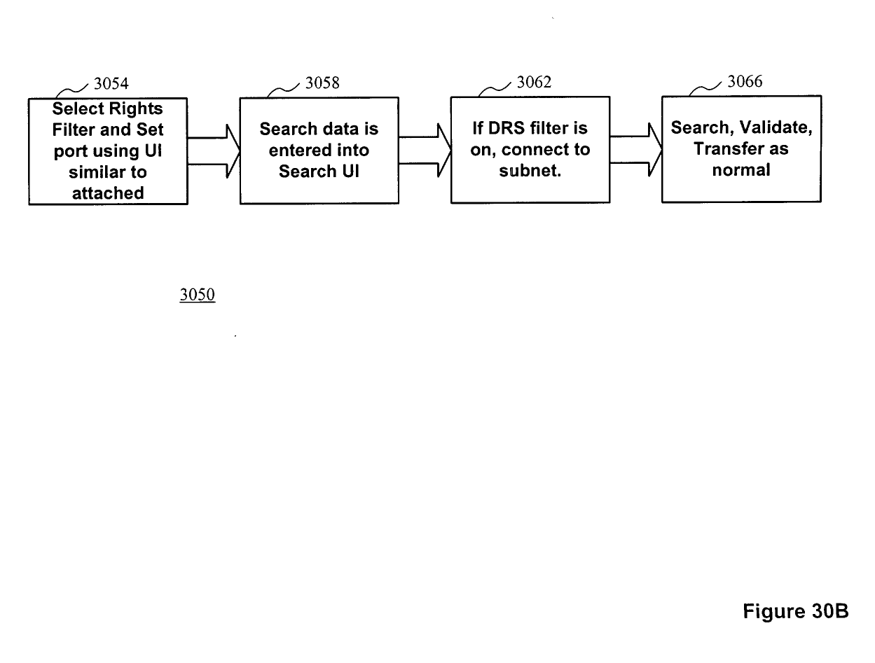

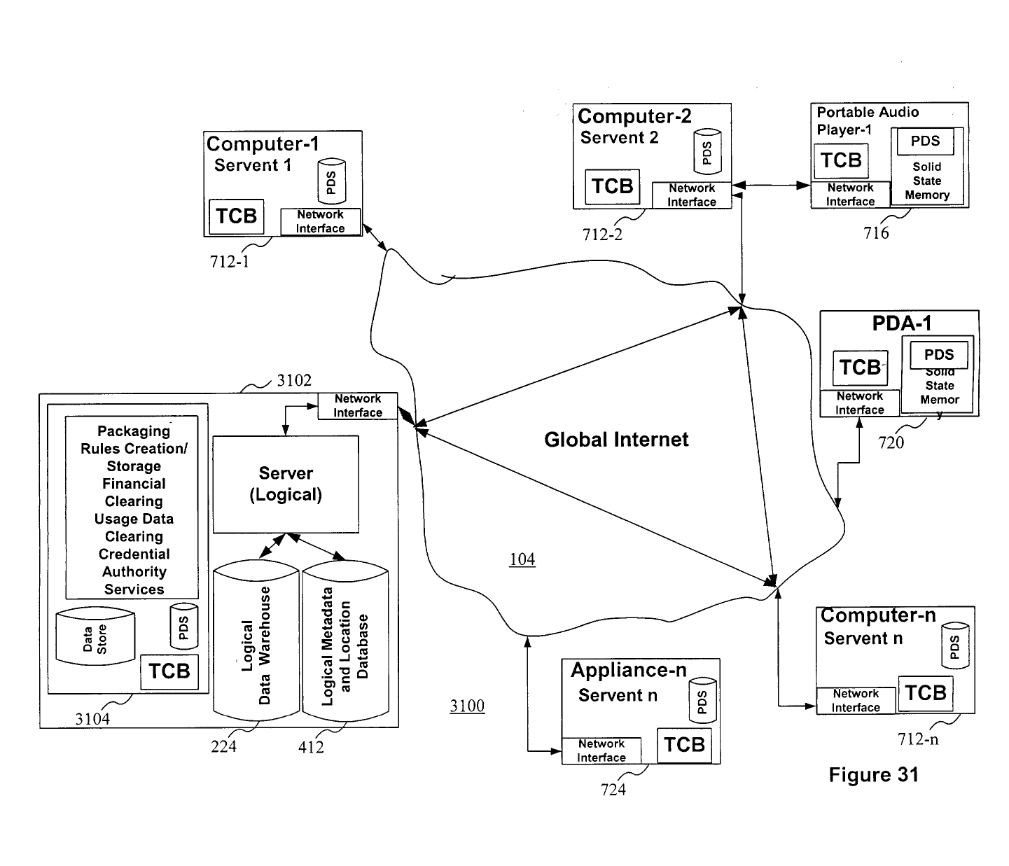

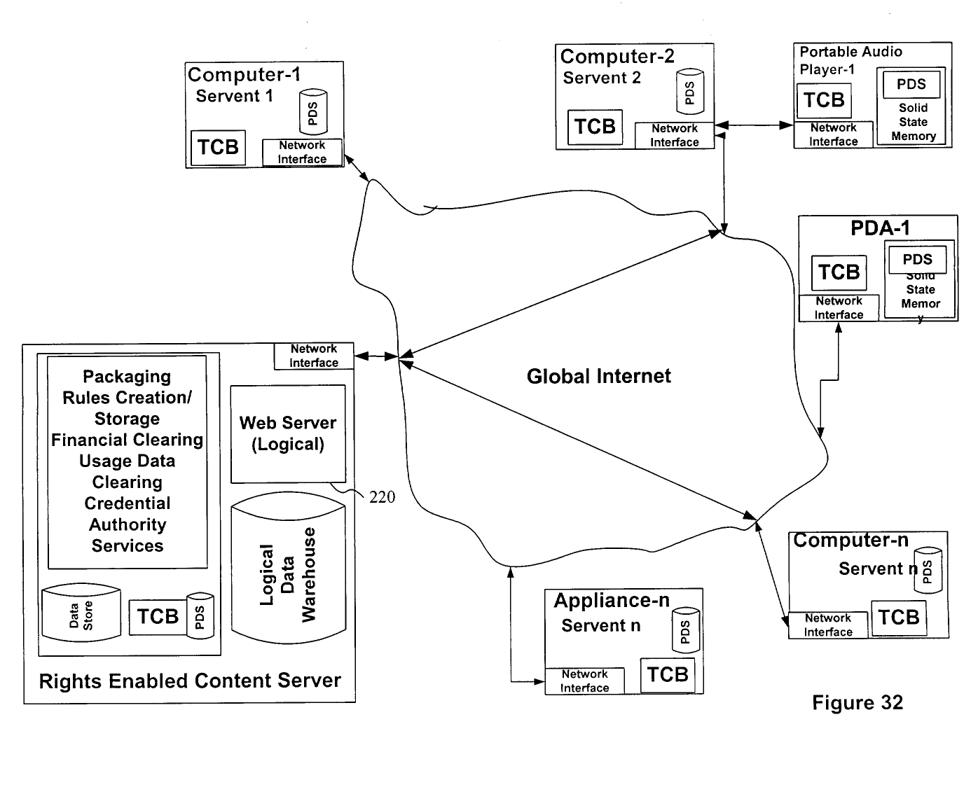

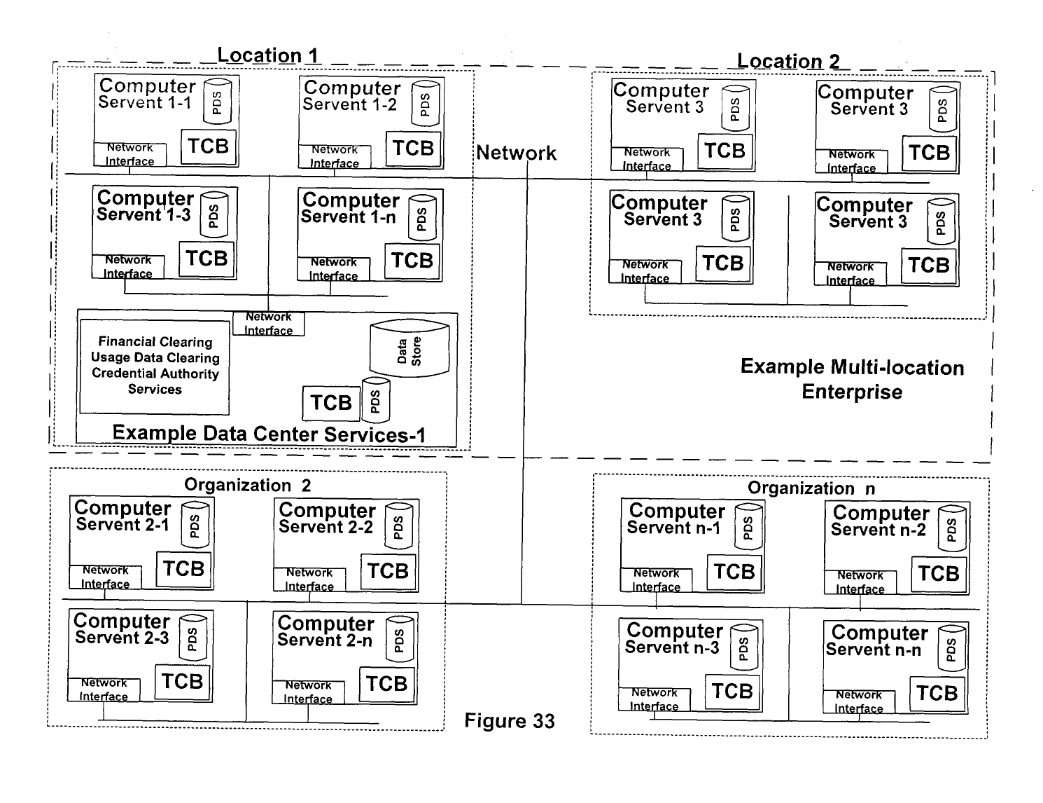

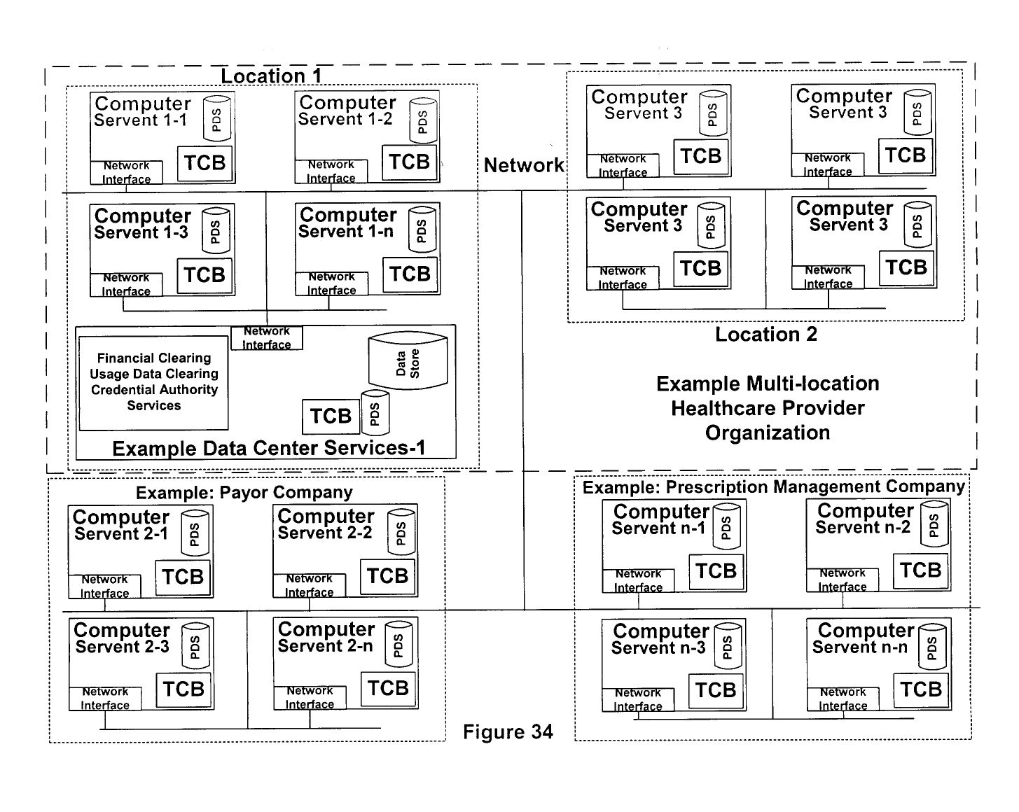

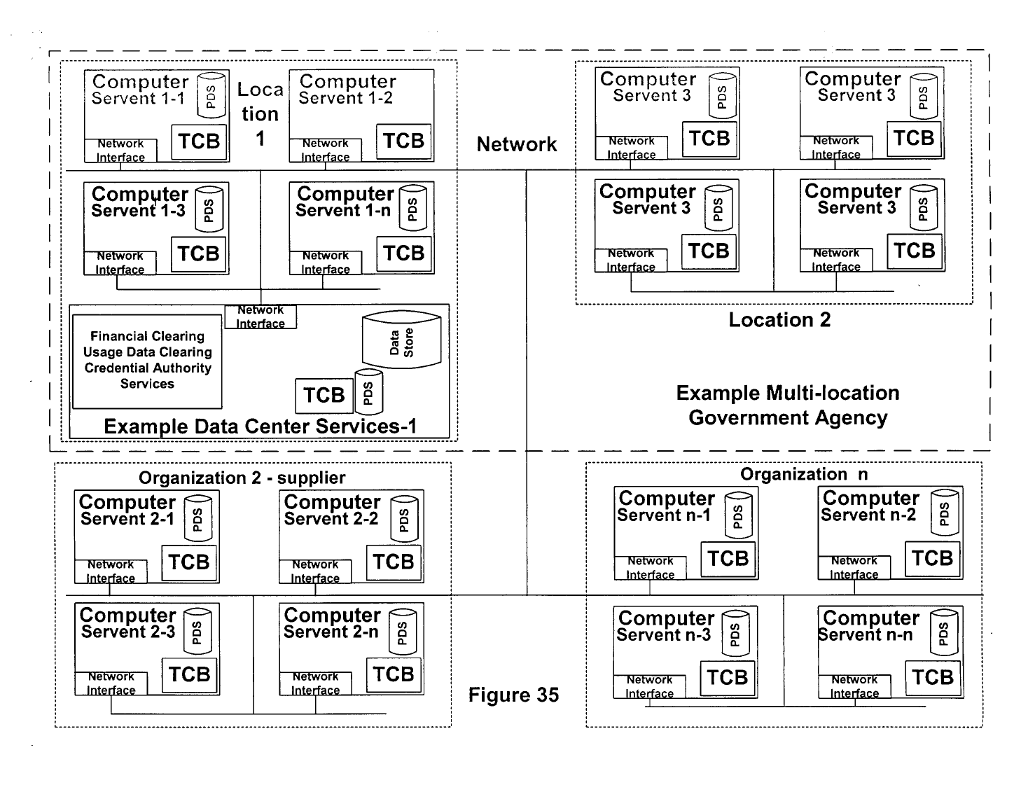

FIG. 4 is a block diagram of an embodiment of an architecture for a peer-to-peer servent;

FIG. 5 is a block diagram of another embodiment of a peer-to-peer network of computers that includes a clearinghouse;

FIG. 6A is a block diagram of an embodiment of a data structure for a searchable secure container (SSC);

FIG. 8B is a block diagram of another embodiment of a data structure for a SSC;

FIG. 8C is a block diagram of an embodiment of a metadata SSC sent in response to a search query;

FIG. 8D is a block diagram of an embodiment of a metadata SSC sent in response to a search query along with a corresponding content cryptographically secure container (CSC);

FIG. 7 is a diagram of an embodiment of extendable markup language (XML) code for metadata including rules and attributes for a CSC;

FIG. 8 is a block diagram of an embodiment of a packaging window for packaging files in peer-to-peer network;

FIG. 9 is a diagram of an embodiment of a watermark error message;

FIG. 10 is a diagram of an embodiment of a authorization verification question window;

FIG. 11 is a diagram of an embodiment of a search results screen;

FIG. 12 is a diagram of another embodiment of a search results screen with one of the possible choices selected;

FIG. 13 is a diagram of an embodiment of an offer description screen;

FIG. 14 is a diagram of an embodiment of a viewer window that shows the contents of the SSC;

FIG. 15 is a block diagram of another embodiment of a packaging window for packaging files in peer-to-peer network;

FIG. 16 is a diagram of yet another embodiment of a search results screen;

FIG. 17 is a diagram of another embodiment of an offer description screen;

FIG. 18 is a flow chart of an embodiment for packaging a SSC that includes plaintext metadata;

FIG. 19 is a flow chart of another embodiment for packaging a metadata SSC and an associated content CSC;

FIG. 20 is a flow chart of another embodiment for packaging a metadata SSC and an associated content CSC;

FIG. 21 is a flow chart of an embodiment 2300 for generating a metadata SSC;

FIG. 22 is a flow chart of an embodiment for processing a search query posed to a servent from a peer computer;

FIG. 23 is a flow chart of an embodiment for validating rules from a metadata CSC against a content CSC;

FIG. 24 is a flow chart of an embodiment for validating and transferring a content CSC;

FIG. 25 is a flow chart of an embodiment for opening a content CSC;

FIG. 26 is a flow chart of an embodiment for searching for and receiving a content file;

FIG. 27 is a flow chart of an embodiment for searching for and receiving a content file via streaming;

FIG. 28A is a diagram of an embodiment of a selection window that allows dynamic subnetting of the interconnected peer computers;

FIG. 30B is a flow diagram of an embodiment for dynamic subnetting via rights selection (DRS);

FIG. 29 is a block diagram of yet another embodiment of a peer-to-peer network of computers that includes centralized searching;

FIG. 30 is a block diagram of an embodiment of a client-server network;

FIG. 31 is a block diagram of an embodiment of a peer-to-peer;

FIG. 32 is a block diagram of another embodiment of a peer-to-peer; and

FIG. 33 is a block diagram of yet another embodiment of a peer-to-peer.

### DESCRIPTION OF THE SPECIFIC EMBODIMENTS

The present invention facilitates the location, distribution, and authorized use of digital information protected by a cryptographically secure container (CSC) by providing an unencrypted portion of a data structure that at least in part describes the rules associated with the protected digital information or content. In some embodiments, the unencrypted portion may describe the protected information as well. These secure containers are referred to as “Rights-searchable™” secure containers (SSCs). In some embodiments the unencrypted rules description or rules metadata may be part of the secure container data structure or may be a separate data structure concatenated with the CSC or may exist as a separate file.

One example benefit of disclosing the associated rules using a SSC is that a user, process, application, system, or any other decision-maker could decide to locate and then retrieve only those SSCs whose rules specify terms and conditions of use that the user is willing and able, or will be able, to meet. Non-limiting examples of using the information that may be disclosed in rights-searchable CSCs include situations where the user may search for and/or retrieve only those containers that can be opened by employees of a certain company or which have a cost associated with use of a one-time charge less than or equal to a specified amount, such as $2.00.

Another benefit of the present invention is that the user may take action to be able to comply with the terms and conditions associated with protected digital information in advance of downloading or transferring the SSC. One example scenario consists of a user determining that the rules associated with a particular file require a payment of $10.00 for unlimited use. This user may only have $5 remaining in a prepaid budget (not unlike a stored value card) and may therefore request additional budget from the appropriate financial clearinghouse or payment processor. After receiving at least an additional $5, the user may then transfer the file and request access. This option may be particularly helpful when the search and retrieval application attempts to open the protected file upon completion of the file transfer process, thus avoiding a situation where the user has transferred the protected information but is unable to meet the required conditions for authorized use.

With reference to FIG. 4, a block diagram of an embodiment of a quasi-peer-to-peer network 400 of computers that includes a centralized data center 404 is shown. Each of the computers 108, 420, 112, 212 include either a search and retrieval (SR) application 408 or SR client software 416 that typically can transfer files from other peers, but cannot search other peer file systems directly. The data center 404 includes the web server 220, the data warehouse 224, the payment processor 228, and a metadata and location database 412.

The SR application and client software 408, 416 in connection with the data center allows the peer-to-peer file transfer. The computers in the network 400 act as server and/or client. More specifically, the data center 404 serves files and provides a centralized directory, a first and second personal computers 420-1, 420-2 send and receive files, the PDA 112, the computer appliance 212 and a third personal computer 420-3 only receive files. The SR application 408 both sends and receives files, and the SR client software 416 only receives files.

All SR applications 408 send their local catalogs of files back to the data center 404 for storage in a metadata and location database 412. Aggregation of all the local catalogs creates a catalog of the whole peer-to-peer network. The metadata may include any kind of attribute information descriptive of each file and is fully searchable such that any of the computers 112, 212, 420 can make downloading decisions based upon that rule information. After a desired file is found by searching, that file can be downloaded directly from one of the peer computers 112, 212, 420.

Referring next to FIG. 5, a block diagram of an embodiment of a rights-enabled appliance 500 with a trusted computing base 504 is shown. Included in the appliance 500 are storage 508, the network interface 128, the trusted computing base 504 and other components known to those skilled in the art, but not shown in the figure.

A packaged file is protected on the rights-enabled appliance 500 according to defined rules that may entail one or more verbs, and attributes or parameters associated with a verb, if any. A verb defines permitted operations using the protected information and/or any consequences of use, examples of which include payment processing and/or audit record creation and reporting. The cryptographically secure container or package provides persistence protection as the file is transported from computer-to-computer such that subsequent parties who encounter the package cannot use the information inside unless allowed to do so by the appropriate verb under the control of a trusted computing base (TCB) 504.

The TCB 504 is a software and/or hardware tamper resistant application, operating system component, or operating system extension. Included in the TCB 504 is a protected execution space 512 or protected processing environment where code is evaluated, interpreted and/or executed. Also it is where encryption, decryption, certificates, and other security related activities are handled. In one embodiment, an InterRights™ Point commercially available from InterTrust™ is used as the TCB 504.

The storage 508 in the rights enabled appliance 500 can be any non-volatile storage media or including flash memory, magnetic discs, and/or read/write optical disks. A protected data store (PDS) 516 or database allows protecting information in storage 508 through encryption, for example. The PDS 516 may be used by the TCB 504 to store rules, audit information, electronic payment information, cryptographic keys, other cryptographic information, digital certificates, credentials, Membership Cards, financial and payment records, usage and audit records, and any other information the TCB 504 wishes to protect in the PDS 516. Information in the PDS 516 can only be accessed through the TCB 504. Other information is stored in a Rights-searchable secure containers (SSC) or packages outside of the storage 508.

These true peer-to-peer (P2P) filesharing applications enable users to search for digital information of interest on any other participating peer system (in storage locations on those peers published to the network) and retrieve that digital information directly from the peer. P2P architectures allow users to determine which of their information shall be made available to the network of participating peers and to retrieve efficiently any and all information of interest to the user. These P2P filesharing applications combine features of more traditional servers and of clients, and hence are sometimes referred to as “servents.”

With reference to FIG. 6, a block diagram of an embodiment of an architecture for a peer-to-peer servent 600 is shown. The architecture shows the various functional units that form the peer-to-peer servent 600. The functional units may or may not be separate pieces of software. Organizationally, the hardware or computer appliance 500 is on the bottom of the figure while the peer-to-peer (P2P) graphical user interface (GUI) 640 is on top.

Starting with the lowest level, the computer appliance hardware 500 provides a processor, storage 508, network interface 128 and other component parts of a standard computer. In other embodiments, any type of computer or suitable appliance with sufficient resources could be used. The operating system 604 interfaces the computer appliance hardware 500 with any application software. Internet transport protocols, network transport protocols, storage interfaces and other functions are supported in the operating system 604.

A P2P file search/transfer protocol 608 sits on top of the operating system 604 to interface the higher level application software with the Internet and network transport protocol interfaces (APIs) of the operating system 604. In one embodiment, the file search/transfer protocol 608 conforms to the Gnutella™ protocol, but any P2P and/or file transfer protocol that supports similar functionality could be used. Extensions to the Gnutella protocol are added to support rights management and extensible markup language (XML) and/or any other self-defining or self-descriptive markup language. Other embodiments could use standard FTP, HTTP, Real, Quicktime file transfer or file streaming protocols.

In communication with the file search/transfer protocol 608 is a functional layer that performs discovery, search and transfer functions 620, 616, 620 and also includes the TCB 504. Discovery 620 is the process for finding other peer computers on the network, and establishing a connection with them. Limits can be put on the discovery process to limit peer computers to those in a specified domain(s), specific networks and/or subnets, those having a specified Membership Card, those having a specified right(s), and/or any other means for limiting the scope of peers that are searchable or participating in a peer-to-peer network. The search function 616 takes search strings and passes them to peer computers and parses the results from those peers. Typically, the search includes at least some rights-related parameters, but searches without rights parameters are also envisioned for convenience, compatibility, and/or interoperability. When a digital information in a SSC is selected for download from a peer, the transfer function 612 manages the SSC transport. Authentication and authorization and possibly other validations maybe required by the transfer function 612 before the file is sent or received.

Streamed media files would be routed through the TCB 504 for creating an at least partially encrypted stream that is then sent to the recipient. A first SSC could be sent that includes a key(s) and rule information to the recipient such that the player could decrypt and play a second SSC that includes the media file. Other embodiments could include the keys, rules and media file in the same SSC. In another embodiment, the SSC and rules governing use are streamed ahead of the partially encrypted information governed by said rules.

Above the functional layer is an API layer that includes the rights management API 624 and the rights enabled P2P API 628. The rights management API 624 interfaces the applications 632, 636, 640 with the TCB 504, and the rights enabled P2P API 628 interfaces the applications 632, 636, 640 with the transfer, search and discovery functions 612, 616, 620.

On top of the API layer is an application layer that includes the P2P GUI 640, a packager 636 and a viewer 632. The P2P GUI 640 is the interface the user interacts with. The packager application 636 allows files to be put into a SSC that could be sent any number of ways to another user. The packager application 636 may also put in a secure container rules, rule parameters, and other objects used by the TCB to evaluate requests for authorized access to the associated protected information. Non-limiting examples of these additional elements include credentials, such as Membership Cards, financial and/or usage clearinghouse information, and other governance related information. When that other user receives the SSC, the viewer application allows displaying and/or playing the protected content under the control of the TCB. The P2P GUI 640 may use a packager 636 and/or viewer 632 through its 640 GUI or separate from the P2P GUI 640.

Referring next to FIG. 7, a block diagram of another embodiment of a peer-to-peer network 700 of computers that includes a clearinghouse 704 and two servers 708 is shown. All the computers in the network 700 include the TCB 504 and the PDS 516. The two servers 708 provide SSCs to the peers, but typically do not receive SSCs from the peers. Conversely, the portable audio player 716 receives its protected information through computer 712-2 and may send back to computer 712-2 certain administrative information, such as acknowledgements, usage information, and other administrative information. PDA 720 typically receives SSCs from the peers, but does not provide any SSCs to the peers.

The clearinghouse 704 receives cryptographically secure containers (CSCs) from the various TCBs 504. These containers may hold payment related information and/or audit information created in accordance with rules governing the consequences of authorized use, if any. Additionally, the clearinghouse 704 may provide credentials such as digital certificates and/or Membership Cards to the users of the peer computers. Payment processing involves receiving a payment record and taking appropriate action. In one example, the payment record indicates the credit card to be charged and the vendor accounts to be credited. In another example, the payment record confirms that a pre-paid budget amount stored in a PDS and managed by the TCB was decremented an amount specified in the payment record. Usage clearinghouse functions include receiving audit or usage records in CSCs, decrypting the CSC and sending the unencrypted usage record to a database application that, in turn, could provide reports to the clearinghouse and to other authorized parties. At least some usage records and resulting reports could indicate time, location, content, and verb exercised by the user. Clearinghouse 704 can also act as a credential authority by providing Membership Cards and other digital credentials to specific qualified users. These digital credentials may include X.509 digital certificates. Membership Cards are sent in CSCs and stored in the appropriate PDS by the TCB upon receipt. In addition to the preceding functions, the clearinghouse 704 could also provide SSC to peers in way similar to the servers 708.

With reference to FIG. 8A, a block diagram of an embodiment of a data structure for a Rights-searchable secure container (SSC) 800 is shown. In this embodiment, plaintext metadata 820 is stored in an XML format. The metadata 820 includes a representation of some or all of the rules stored in an appended content CSC 824. By having the rule information in the clear, the rules can be the subject of search queries without opening the CSC that protects the information whose authorized use is defined by the rules. Servers and servents 708, 712 that store the SSC 800 can pull rules and other information about the CSC 824 from the metadata 820 to allow easy indexing of the SSCs 800.

A header 816 provides information about the SSC 800. For example, the header could indicate which type of SSC the header is associated with. The header 800 indicates for this type of SSC where the metadata 820 and CSC 824 are located in the SSC 800. Other information may also be stored in the header. By reading the header the transfer function 620 knows what part(s) of the message should get sent to the TCB 504 for decode.

Referring next to FIG. 8B, is a block diagram of another embodiment of a data structure for a SSC 804 is shown. In this embodiment, metadata 832 is stored in a separate CSC. In this way, the metadata cannot be tampered with. The header 828 indicates where the metadata CSC 832 and content CSC 824 can be found in the message. Other information may also be stored in the header.

With reference to FIG. 8C, a block diagram of an embodiment of a metadata SSC 808 sent in response to a search query. During a search, each server 708 or servent 712 has a catalog of files that includes rule information, file attributes and attributes related to the server or servent. If there is a hit from the search query, the server or servent 708, 712 sends back metadata that describes the file that caused the hit. The metadata SSC 808 includes the metadata describing the file and a code that uniquely identifies the file. Because a CSC is used, the information within the CSC cannot be tampered with. When the content CSC is later received the code is checked against another code in the content CSC to be sure there is a match. A header 830, among other things, indicates where the metadata CSC begins. Although not shown, some embodiments could include the search query in a CSC so as to avoid non-peers from observing what a user is searching for.

Referring next to FIG. 8D, a block diagram of an embodiment of a metadata SSC 812 sent in response to a search query along with a corresponding content CSC 816 is shown. This embodiment includes a code or reference 836 that indicates the content CSC 816 is the streaming content requested. The code 836 can be part of another CSC or encapsulated within its own CSC.

With reference to FIG. 9, a diagram of example XML code for metadata 820 including rules and attributes associated with protected information within a CSC is shown. In the XML code 820 are information pertaining to offers 904, digital content information 908 and credentials 912. The offers 904 include rules some of which may be comprised at least in part by verbs. For example, according to this example XML-encoded metadata, the ability to play the content file is permitted by at least one rule provided any conditions associated with that rule are satisfied. In the content information section 908 of the XML, includes attributes about the file such as the publisher, data rate, encoding formation, size, file name, etc. The credential section 912 includes a listing of credentials required to access the encapsulated file. It is noted that there may be more that one credential specified such that a user with any of the credentials listed could use the associated encapsulated file. In another example, plural credentials may be required to gain authorized access to the protected digital information. Although XML is used in this embodiment, any data structure could be used. Preferably, the data structure is self-describing such that the parser determines what it is parsing from the data structure itself.

Referring next to FIG. 10, a block diagram of an embodiment of a trusted packaging window 1000 is shown. The packager application interacts with TCB 504 through the rights management API 624 to create a cryptographically secure container. Optionally, the user can either send the protected file without providing a plaintext description of the associated rules, in which case the “NO” check box 1032 would be checked, or as in the present example, with the rules metadata unencrypted as described by the XML-encoded metadata in a SSC 804. If the user checks the “YES” box 1028 as in this example, searchable forms of the verbs are always available outside the encrypted portion of the container data structure that protects the rules. In another embodiment, creating a rights-searchable secure container may be the default for any packaging operation that entails rules and related control information.

The user selects the file name(s) to include in the SSC 804 with a file name entry 1004. Rules 1008, credentials 1012, financial clearinghouse 1016, and usage clearinghouse 1020 information may also selected. As indicated in FIG. 10, only one verb is required and that would almost always enabling viewing or playing the protected information. However, any number of rules 1008 in the form of verbs can be specified to control the file in the SSC. For example, a first verb requires a one-time fee of $1.98 to allow the purchaser to play the “black friday.mp3” any number of times. A second verb gives an alternative offer to allow playing the song for 25 cents each time.

The credential fields 1012 allow specifying credentials the user must have before accessing the protected file. Credentials could be digital certificates or Membership Cards. A Membership Card is a persistent protected file or object issued to one or more persons, processes, and/or InterRights Point installations for authorization purposes. However, this embodiment requires no credentials.

Still referring to FIG. 10, Membership Cards may also define certain contexts where fair-use copyright exemptions may apply. For example, the protected information may be packaged with a standard commercial price and a discounted price for those having a Membership Card or other acceptable credential indicating that the user had some affiliation with an institution where fair use exemptions were likely to be granted by rightsholders, for example, a library or educational institution.

The clearinghouse fields 1016, 1020 allow specifying where audit and payment-related information should be sent. The person who packages the information may be able to choose among a number of clearinghouses. Based upon those specified, the TCB 504 of the recipient will send payment information to the financial clearinghouse 1016 and usage information to the usage clearinghouse 1020. For example if the recipient chooses to pay 25 cents for each play, the TrustData™ Usage Clearing Services usage clearinghouse is notified by the creation and reporting of an audit record. In this non-limiting example, if the recipient has some sort of local budget managed by TCB 504 and stored in PDS 516, the 25 cents is subtracted from the stored value amount or the unused authorized credit amount. These charges may be reported to the financial clearinghouse 1016, in this example the TrustData Local Budget clearinghouse. In another example, there may not be sufficient funds locally, and if connected, the TCB may attempt to effect payment in real time using the financial clearinghouse represented by the TrustData Immediate Payment financial clearinghouse. Some kinds of digital information, including, but not limited to audio, video, image, and software may carry one or more watermarks or fingerprints encoded in the digital information. In the non-limiting embodiment shown here, a list of currently available and active watermark detection plug-ins 1024 are listed in the packaging window 1000. The one or more listed watermark algorithms will be used to recognized information encoded within or by the watermark in the content file itself, if present. By having a plug-in architecture, code implementing new watermarking algorithms may be added easily for use by the packaging application. Code implementing one or more watermark detection algorithms may be user installed or installed by the developer of the packager application component. If user installed, the plug-in may be required to present a credential or certificate to the TCB 504 before it's use is permitted by the TCB 504.

If a watermark is found, the publisher or other party about to package the watermarked information must show that they are authorized to distribute the watermarked material using rights management technologies that employ a CSC, or the packager will not package the file. Authorization to package watermarked files may be granted using a suitable credential such as a Membership Card or an X.509 digital certificate. Upon detecting a watermark of a particular kind and with certain information contained therein, the packaging application may determine if the user has a valid authorization credential stored in a PDS 516 controlled by a TCB 504. If the appropriate valid credential is found, packaging may proceed. This prevents unauthorized parties publishing files using this packaging application that have been previously protected with a watermark. Credentials may be used to represent any rightsholder or their agent in the digital information supply and distribution value chain, non-limiting examples of which include musicians, record labels, television channels, such as MTV and/or VHI, music distributors, web portals, and other authorized parties.

In another embodiment, a plug-in may compare a sample of the music to be packaged with samples stored elsewhere to determine if that particular recording is protected under copyright. The comparisons might be between hash codes calculated over a sample of some predefined length rather than between samples of the audio. Once identified, a database could return a value indicating whether copyright was asserted or not, and if asserted, who the rightsholder is for that particular recording. The packager application could then make additional decisions based on that information and/or the presence of appropriate credentials.

In yet another embodiment, the packager could look to see if the file incorporated metadata that described attributes of the recorded music, such as the appropriate field within an MP3 header file that is reserved for the International Standard Work Code or the International Standard Recording Code, information that identifies the work and/or the specific recording of the work. The packager application could then make additional decisions based on that information and/or the presence of appropriate credentials.

With reference to FIG. 11, a diagram of an embodiment of a watermark detection error message is shown. This example message is shown when there is a watermark found in a file that someone has attempted to package without the packaging application through the TCB 504 finding an appropriate valid credential in PDS 516.

Referring next the FIG. 12, a diagram of an embodiment authorization verification question window 1200 is shown. When a person attempts to package a file, an attestation of ownership or possession of similar rights is required. This example window asks the person about to package digital information of any kind whether that person has the authority to do so without violating the copyright(s) and/or other proprietary, legal, and/or contractual rights of another person. If the user uses a mouse or other pointing device to click on “Yes” button 1204, then packaging will proceed. This attestation is subsequently reported to an audit clearinghouse in accordance with rules for audit records related to the packaging function. In this way, the person packaging the digital information can be identified if their ownership is subsequently questioned. If the person clicks on “No” button 1208, then the packaging process is terminated. In another embodiment, the packager may check to see if there are one or more certain Membership Cards and/or other credentials known to the TCB 504 and if so, proceed with packaging without asking whether the person about to package the content is authorized to do so. Combinations of Membership Cards and/or other credentials may also be used to determine if audit records are created and reported to a usage clearinghouse.

With reference to FIG. 13, a diagram of an embodiment of a search results screen 1400 is shown. A user of the P2P network entered “Steeley Dan” as an example search term and five resulting SSC files were returned. Listed are a series of verbs 1304 and values 1308 for each file. The value 1308 gives a description of its associated verb 1304. Any number of verbs 1304 are possible for each file. The verbs are returned from the metadata XML 820 maintained unencrypted outside the encrypted portion of content CSC 824 that holds and protects the digital file which in this non-limiting example, is a compressed audio file containing music.

To get additional information on any item on the list, the user can right click for more verbose explanations. Each file can be selected for downloading or streaming. Streamed files are played as they are downloaded. In other embodiments, more sophisticated searching is possible such that a user could search for specific verbs or file types. For example, a user could search for a one-time charge of less than $1.00.

There are display options available to further simplify the search results. For example, any verb value column 1308 may have a sort criteria applied to it such as price. It should be also noted that the same verbs are organized in the same columns to make comparing the different offers easier. In another embodiment, received search results may be redisplayed with a more limiting set of search criteria without having to perform the all over again.

FIG. 14 is a diagram of another embodiment of a search results screen with one of the possible choices selected. In these search results there are two listings for the song “Bad Sneekers.ssc.” There can be more than one version because of multiple instances of the same file, different packaging times or versions of the song, etc. In another embodiment, multiple instances of the same file located on one or plural participating servents 600 could be displayed to the user. In this example results screen, the second version of the song allows for a discount if the use of the song can be audited by the publisher. If agreed to by the user, an audit record would be created perhaps each time the song was played and reported to the usage clearinghouse designated by the packager of the song. As an additional example, there are multiple versions of the “Black Friday Lyric.ssc” that have identical verbs, but are available on different peer computers. In one embodiment, the user could retrieve the file located on the peer with the fastest internet connection.

FIG. 15 a diagram of an embodiment of an offer screen 1500 is shown. In the preferred embodiment, this offer screen is controlled by TCB 504 and indicates the rules that are protected by the CSC 824. Because the TCB controls the display of actual rule information, the user is assured that the offer is accurate and genuine. If there is a discrepancy between the rule information contained in the example XML-encoded plaintext 820 and the protected rules, the information shown in this example message is definitive. Once downloaded from the peer computer, the recipient can choose an offer that suits them. Further information on any offer may be retrieved from the CSC 824 that holds the rules and related governance information.

FIG. 16 is a diagram of an embodiment of a trusted viewer window 1600 that shows at least some of digital information protected in the SSC. Information displayed by the trusted viewer is controlled by a TCB 504 in accordance with the rule(s) agreed to by the user. In this example, the contents of Black Friday Lyric.txt.ssc is shown in the viewer window. Following from the selected file in FIG. 14, this file can be viewed once for $1.00, viewed multiple times thereafter for 50 cents, or printed one time for $4.99. It is noted that once the rights are purchased in some embodiments they are portable and may follow and/or be transferred by that user from machine to machine by various methods. Although this example is for a text viewer, there are viewers available for all types of content files such as audio, video, image, and other file types.

With reference to FIG. 17, a block diagram of another embodiment of a packaging window 1700 for packaging files in peer-to-peer network is shown. In this embodiment, the watermark capability is omitted and additional functionality is given to the credential selection 1012. Boolean combinations of credentials are possible by with a Boolean selection button 1704. Operators such as AND, OR and NOT are supported in this embodiment. For example, a company credential and a corporate office credential or a corporate planning department credential is required to view, print or modify the CompanyBizPlan2000Draft.doc file. Although not depicted, further embodiments could entail sunrise and sunset parameters for one or more of the verbs.

The active watermark plug-in window 1024 is not shown in this embodiment because there are not any watermarking algorithms used to protect files in this format, but strong and robust watermarking algorithms for text could be used as they become available. A financial clearinghouse is specified to allow chargebacks upon accessing the file. Additionally, usage is monitored by audit records sent to a usage clearinghouse.

Referring next to FIG. 18, a diagram of yet another embodiment of a search results 1800 screen is shown. The results show the credentials required 1804 and the verbs 1808 associated with those credentials. When a search was done for “CompanyBizPlan*.*”, four results were produced. The older versions have fewer or more restrictive rights because they were not provided when packaged or because some rights were sunsetted over time. For example, the older business plans can no longer be modified. Some rights can be sunrised. For example, a company undertaking an Initial Public Offering may make their business plan, annual results, quarterly results, or SEC registration document directly available to all employees after a SEC quiet period expired.

With reference to FIG. 19, a diagram of another embodiment of an offer description screen 1900 is shown. In the preferred embodiment, this screen is controlled by a TCB 504 and accurately reflects the rules protected in the CSC. This description indicates company officers and members of the planning group can view the file as many times as they want before Dec. 31, 2001 at 6:00 p.m. when the offer is sunsetted.

Referring next to FIG. 20, a flow chart of an embodiment 2000 for packaging one embodiment of a SSC 800 that includes plaintext metadata 820 is shown. Generally, the left of the flow chart shows the input components, the right of the flow chart shows the output components, and the actions are shown in the middle. In step 2004, a rights offers user interface (UI) 1000, 1700 selects the rights, credentials and clearinghouses for a content file selected in step 2008. More than one file can be selected for the package in step 2008. Block 2012 represents the content file(s) selected for packaging.

The rules embodied in the rights, credentials and clearinghouses information are passed to steps 2020 and 2024. In step 2020, the rights are used to generate the plaintext XML metadata 820. The content file(s) selected in step 2008 is used in step 2024 along with the rights to create the content CSC 824. Before creation of the content CSC 824, the content file(s) is checked with a third party watermark plug-in in optional step 2028. The header 816 is created in step 2016 by with data relevant to the plaintext XML metadata 820 and the content CSC 824. In most embodiments, the Build Header Information step 2016 completes after the metadata plaintext creation step 2020 and the Generate CSC step 2024 complete or at least after each has progressed sufficiently so that the length of the metadata plain text 820 and of Content CSC 824 are known.

With reference to FIG. 21, a flow chart of another embodiment 2100 for packaging a metadata SSC 812 and an associated content CSC 816 is shown. This embodiment 2100 produces a metadata SSC 812 separate from a content CSC 816. In step 2104, the rules are used to generate a metadata CSC 832. A reference code 836 that uniquely identifies the content CSC is generated in step 2108. The reference code 836 can be verified with information inside the content CSC 816. Also in step 2108, the content CSC 816 is generated. The content CSC 816 holds the content files 2012. In most embodiments, the Build Header Information step 2016 completes after the metadata plaintext creation step 2104 and the Generate CSC step 2108 complete or at least after each has progressed sufficiently so that the length of the metadata plain text 832 and of the Reference to Content CSC 836 are known.

If at least one watermarking plugin has been provided to the application for the data format being packaged, packaging is not performed if a watermark is found and there is no authorization in the form of one or more credentials such as a Membership card and/or a digital certificate in X.509 format.

Referring next to FIG. 22, a flow chart of another embodiment 2200 for packaging a SSC 804. In this embodiment, the metadata CSC 832 is part of the same message as the content CSC 824. The metadata CSC is generated in step 2204 from the rules entered in step 2004.

With reference to FIG. 23, a flow chart of an embodiment 2300 for generating a metadata SSC 808 is shown. The metadata SSC 808 is generated in response to a file query. Rules 2312 are used in step 2308 to package the metadata CSC 832.

Referring next to FIG. 24, a flow chart of an embodiment 2400 for processing a search query posed to a servent 712 from a peer computer is shown. To perform a search across the available peer network, in one embodiment many peer computers are sent the same search query such that many peer computers perform this processing in parallel. In one embodiment, the search request received from the Internet 104 in step 2404 can be in a CSC. In step 2408, the XML query is parsed. Each servent 712 may maintain a content database (DB) 2416 of all local shared files with metadata including rules metadata related to CSCs for each stored in the DB in indexed fashion. In step 2412, the content DB 2416 is searched. Any hits from the search may be individually packaged into a metadata SSC 808 in step 2300 and returned to the requesting peer computer. Other embodiments, could package many hits from the search query into the same metadata SSC 808. In another embodiment the search results are sent without being encrypted using the appropriate response and transport protocols.

With reference to FIG. 25, a flow chart of an example embodiment 2500 for validating rules from a metadata CSC 832 against a content CSC 816 is shown. Validation occurs at a number of different times in the process. For example, the validation is performed when a SSC is sent to a requesting peer computer or when a file transfer request is received. In this way, both ends of the transaction check that the metadata matches the content CSC 816.

In steps 2504 and 2508, the metadata CSC 832 and the content CSC 816 are retrieved. Both CSCs 832, 816 are unpackaged in step 2512 to get the rule information. Other embodiments that store the metadata in the clear would not require unpackaging and/or decrypting metadata. The metadata is compared in step 2516 to see if there is a match.

Referring next to FIG. 26, a flow chart of an embodiment 2600 for responding to a file transfer request is shown. In step 2604, the file transfer request is received. The transfer request includes the metadata SSC 808 sent in response to the search query. A search is performed in step 2400 to find the content CSC 816. The metadata SSC 808 is checked against the rules in the content CSC 816 in step 2500 to verify the correct file is being requested. In step 2608, the content CSC is transferred to the requesting peer computer. In other embodiments the file may be transferred upon receipt of a request from another peer without further metadata check and validation as long as the requested file is found locally (and in some embodiments, on a portion of the file system specifically allocated for storing files shared with other peers).

With reference to FIG. 27, a flow chart of an embodiment 2512 for opening a content CSC 816 is shown. In step 2704, a request is sent for retrieval of the content CSC 816. The request includes the metadata SSC 808 sent in response to the search query. The peer receiving the retrieval request validates that request in step 2500. In step 2708, the protected information is accessed under control of the TCB 504 in accordance with rules associated with the protected content. If there is a fee for accessing the information, the sale processing under the control of the TCB 504 in accordance with rules relating to payment consequences. Communication with a financial and audit clearinghouse 2712 provides payment and/or a record of the transaction if the actual payment event occurred using a locally stored budget or authorized credit. Other embodiments could perform the payment at a later time if there is currently no connection to the clearinghouse 2712. The payment record would be kept in the PDS 516 until such time as the TCB 504 determined that a network connection existed and/or until the TCB 504 requested that the user establish a connection because a clearinghouse or other party had set a rule with a threshold indicating how frequently the TCB should communicate with a clearinghouse. In step 2716, the user is allowed to use the content using a trusted viewer or player under the control of TCB 504.

Referring next to FIG. 28, a flow chart of an embodiment 2800 for searching for and receiving a content file is shown. In step 2804, search criteria is gathered from a user interface (UI) 1000, 1700 window. A formatted XML search query is generated in step 2808 that will be compared to metadata on peer computers. The query is sent to connected peer servents 712 in step 2812 by way of the Internet 104. Typically, many peer servents 712 receive the query and check for hits or matches locally.

Responses from all the peer servents 712 are gathered in step 2816 and displayed in a results window 1300, 1800. The responses may arrive in the form of metadata CSCs 808 and are checked against the original query in step 2818. A verification icon could be presented in the results window next to each verified entry. After one of the entries is selected for receiving, a request is made to the servent 712 that hosts the file in step 2820. The request includes the metadata CSC 808 such that the content CSC 816 can be checked against the metadata CSC 808 before sending the file. Once the file is validated by the host computer, it is sent to the requesting computer in step 2824. In another embodiment, the search results are sent unencrypted.

With reference to FIG. 29, a flow chart of an embodiment 2900 for searching for and streaming a content file is shown. This embodiment is similar to that of FIG. 28, but the file requested is streamed in step 2916. Additionally, only the file selected is verified in step 2818 before it is requested in step 2912. In another embodiment, a CSC with the rules associated with the information to be streamed is sent to the receiving peer. The receiving peer presents the rules to the user who may agree to the conditions of use and provide payment, if any. Upon satisfaction of the rules, a message may be sent to begin streaming the information which may be in another CSC or which may be at least partially encrypted. The first CSC may also contain the key required to decrypt the at least partially encrypted streaming information.

Referring next to FIG. 30A, a diagram of an embodiment of a selection window 3000 that allows dynamic subnetting of the interconnected peer computers based upon rights selection. The rights filter(s) specified in 3008 are associated with a TCP port in 3004. Only the computers on the same port 3004 will communicate with each other. Multiple conditions can be enabled 3012 simultaneously by connecting with multiple subnets at the same time.

For example, if the first two entries in the selection window are enabled, free files found on port 2001 and files requiring the company Membership Card on port 2002 will be subnetted separately. Only those peer computers that are in the associated subnets will receive the search queries. In other embodiments, Boolean combinations of rules could provide more powerful subnetting possibilities.

With reference to FIG. 30B, a flow diagram of an embodiment 3050 for dynamic subnetting via rights selection (DRS) is shown. In step 3054, a DRS selection window 300 is used to select the subnet filter characteristics. A search criteria is entered into a search window 1000, 1700 in step 3058. In step 3062, the search criteria are only sent to peer computers within the DRS filter subnet defined in step 3054. Processing of the search results proceeds as normal in step 3066 among the subnet computers.

In other embodiments, participation in P2P networks may be limited to servents having certain qualified domain names, to those with certain network addresses, to those accessible over a virtual private network(s), and other means for limiting access known to those skilled in the relevant arts.

Referring next to FIG. 31, a block diagram of yet another embodiment of a peer-to-peer network 3100 of computers that includes centralized searching is shown. In this embodiment a centralized data center 3102 provides a directory 412, data warehousing 224, financial and usage clearinghouse 3104, and packaging 3104 functions. New files may be packaged in block 3104 and at any servent 724. Files may be exchanged among the peer computers 3102, 712, 720, 724. The PDA 720 and portable audio player 716 are limited to receiving content files because of resource constraints. The servents 724 can both provide and receive content files. The metadata in the metadata and location database 412 is gathered from the metadata CSC 808 associated with each content file.

In this embodiment, servent applications, other search and retrieval applications, and/or browsers running on computers 712, 720, and appliance 724 may search the metadata and location database that contains at least in part rules-related metadata associated with CSCs stored in data warehouse 224 and/or on other peers. Files of interest to the user may be retrieved from the data warehouse 224 and/or from other peers whose network location is provided from the metadata and location database 412.

With reference to FIG. 32, a block diagram of an embodiment of a client-server network 3200 is shown. Each client computer 712, 716, 720, 724 communicates with a central server 3204 for content files including content protected in rights-searchable CSCs. The data warehouse stores 224 rights-searchable content CSC and plaintext rules metadata to make rules-based searching easier. The central server 3204 may also have packaging and clearinghouse capabilities. In addition to P2P search, the servent software may communicate with Web Server 220 and receive its search results and files from a centralized service.

Referring next to FIG. 33, a block diagram of an embodiment of a peer-to-peer network 3300 is shown. Peer-to-peer networking has been conceived and implemented mainly in the context of individuals sharing unprotected information, especially entertainment information in the form of compressed audio recordings. However, the present inventions may be used in business contexts as well. In this embodiment, there are two locations 3308 of one organization 3304-1 networked with two other organizations 3304-2, 3304-3 such that all servents 712 on the network 3300 are connected. A central clearinghouse 3312 provides various services to the whole network. All of these computers may participate in P2P sharing of protected information stored in rights-searchable CSCs. As those skilled in the art would appreciate, any combination of network components is possible. Subnetting could be used to interconnect the servents 712 in a larger peer-to-peer group. Additionally, virtual private networking could be used to further subnet these groups.

In this embodiment, participants within a single organization could search for, locate, and retrieve company information that had been packaged with rules requiring the presence of a Membership Card indicating employment or other affiliation with the example company. In addition, participants in one or another value chains might also share protected digital information that had been packaged with a rule requiring that the user possess at least one specific Membership Card indicating that the party was an authorized participant in a specific value chain. Access to participating computers may be effected by one or more of the subnetting techniques previous discussed herein and/or others that may become known in the future

With reference to FIG. 34, a block diagram of another embodiment of a peer-to-peer network 3400 is shown. This example embodiment shows the application of the present inventions within a particular vertical market, that is, within healthcare. Referring to FIG. 34, two locations 3404 of a healthcare provider organization 3408-1 integrated with an off-site payor company 3408-2 and an off-site prescription management company 3408-3. All of these computers may participate in P2P sharing of protected information stored in rights-searchable CSCs. Access to participating computers may be effected by one or more of the subnetting techniques previous discussed herein and/or others that may become known in the future

Referring next to FIG. 35, a block diagram of yet another embodiment of a peer-to-peer network 3500 is shown. This embodiment shows two locations 3504 of a government agency 3508-1 integrated with an off-site supplier 3508-2 and another off-site organization 3508-3. All of these computers may participate in P2P sharing of protected information stored in rights-searchable CSCs. Access to participating computers may be effected by one or more of the subnetting techniques previous discussed herein and/or others that may become known in the future

A number of variations and modifications of the invention can also be used. For example, servers could have their various components spread among a number of computers and/or locations, but are connected logically in one congruous whole.

While the present invention has been described with reference to certain preferred embodiments, it is to be understood that the present invention is not to be limited to such specific embodiments. Rather, it is the inventor's intention that the invention be understood and construed in its broadest meaning as reflected by the following claims. Thus, these claims are to be understood as incorporating and not only the preferred embodiment described herein but all those other and further alterations and modifications as would be apparent to those of ordinary skill in the art.

What is claimed is:

1. A method for packaging content and rules for securely transference of said content over a network, comprising the steps of:
specifying content to be secured;
specifying rules associated with said content;
generating metadata representative of said content and said rules;
encrypting said content in a secured container in accordance with said rules;
packing said metadata and said secured container together with header information.

2. A method as recited in claim 1 wherein said metadata representative of said content and said rules is searchable.

3. A method as recited in claim 1 wherein said metadata is encrypted in accordance with metadata packaging rules for securing said metadata in a second secured container.

4. A method as recited in claim 3 wherein said encrypted metadata in said second secured container is searchable.

5. A method as recited in claim 1 wherein in said encrypting step said content is verified with watermark information.

6. A method as recited in claim 1 wherein said rules specify rights required for accessing said content.

7. A method as recited in claim 1 wherein said rules specify one or more credentials required for accessing said content.

8. A method as recited in claim 1 wherein said rules specify one or more required clearinghouse information.

9. A method for packaging content and rules for securely transference of said content over a network, comprising the steps of:
specifying content to be secured;
specifying rules associated with said content;
generating metadata representative of said content and said rules;
encrypting said content in a secured container in accordance with said rules;
packing said metadata and a reference to said secured container together with header information.

10. A method as recited in claim 9 wherein said metadata representative of said content and said rules is searchable.

11. A method as recited in claim 9 wherein said metadata is encrypted in accordance with metadata packaging rules for securing said metadata in a second secured container.

12. A method as recited in claim 11 wherein said encrypted metadata in said second secured container is searchable.

13. A method as recited in claim 9 wherein in said encrypting step said content is verified with watermark information.

14. A method as recited in claim 9 wherein said rules specify rights required for accessing said content.

15. A method as recited in claim 9 wherein said rules specify one or more credentials required for accessing said content.

16. A method as recited in claim 9 wherein said rules specify one or more required clearinghouse information.

17. A method for searching and retrieving contents stored in secured containers wherein each of said containers having an associated metadata describing the respective secured content, comprising the steps of:
receiving a query describing content to be retrieved;
parsing said query to extract one or more search parameters from said query;
searching metadata indices using said search parameters to generate search results, wherein each of said metadata indices represents and references a particular set of rules and content in a cryptographically secured container; and
returning said search results.

18. A method as recited in claim 17 wherein said metadata are stored in xml form.

19. A method as recited in claim 17 wherein said search results are returned in encrypted form.

20. A method for searching and retrieving contents stored in secured containers wherein each of said containers having an associated metadata describing the respective secured content, said metadata encrypted in metadata secured containers, comprising the steps of:
receiving a query describing content to be retrieved;
parsing said query to extract one or more search parameters from said query;
decrypting said metadata in said metadata secured containers to generate metadata indices;
searching said metadata indices using said search parameters to generate search results, wherein each of said metadata indices represents and references a particular set of rules and content in a cryptographically secured container; and
returning said search results.

21. A method as recited in claim 20 wherein said metadata are stored in xml form.

22. A method as recited in claim 20 wherein said search results are returned in encrypted form.
